(19) United States
(12) Patent Application Publication
(10) Pub. No.: US 2015/0095971 A1
(43) Pub. Date: Apr. 2, 2015

(54) AUTHENTICATION IN COMPUTER NETWORKS

(71) Applicant: Jonathan Roffe, London (GB)

(72) Inventor: Jonathan Roffe, London (GB)

(21) Appl. No.: 14/390,571

(22) PCT Filed: Apr. 5, 2013
(86) PCT No.: PCT/EP2013/057234

§ 371 Date: Oct. 3, 2014

(30) Foreign Application Priority Data
Apr. 5, 2012 (GB) 1206203.0

(51) Int. Cl. H04L 29/06

(52) U.S. Cl. CPC H04L 63/08; H04L 63/20
USPC 726/1; 726/3

(57) ABSTRACT

Trusted and/or secure communication in transactions between objects or users in a computer network, which do not require imposition of an overseeing authority or system, but wherein security measures are agreed between the parties, leading to a legally enforceable agreement, the process of agreement comprising the formation of a relationship between the first and second objects, by exchanging preferably identity data with the other to a mutually satisfactory degree, the identity data including reference identity data, and the network optionally including one or more audit mechanisms for providing independent verification of the reference items, agreeing data safeguarding procedures to be carried out, and providing a configuration file which regulates transactions between the users and which specifies the conditions under which communication transactions may take place between the users, the degree of identity data to be exchanged, the identity reference data required, and the type and amount of data safeguarding employed.

This invention relates the authentication in computer networks in particular to the maintenance of security in computer networks.

### BACKGROUND ART

A well-known problem when transmitting documents and messages across computer networks, such as the Internet, is that of authenticating the parties. Identification and authentication mechanisms normally assume that the subordinate party (a ‘user’) is required to provide credentials to the superior party (often a ‘server’). Digital signatures have been developed, which usually require a third party often known as a Certificate Authority (CA) within the Public Key Infrastructure (PKI) model to create and verify the signatures. The CA will generate secret keys of two parties desiring to communicate, and these keys may be used either for the purposes of verifying a digital signature attached to a transmission, and/or for securely encrypting the transmission. Thus when a message is sent from A to B, an object may be secured with A by encrypting items of data, using the key provided by the CA and sent to B. Additionally, either A or B can refer to the CA to ensure that the keys used for either encryption or signing are genuine. This mechanism is deeply flawed in both design and execution for a number of reasons including that there is no demonstrable relationship between the key and the holder of the key, and the model has been subverted on a number of occasions.

Encryption algorithms may employ symmetric or asymmetric keys. Symmetric keys are those which are used both for encoding and decoding. They are more secure in general use but require more careful storage as, if compromised, security is lost. Asymmetric keys use different keys for encryption and decryption. Public key algorithms make the encryption key of the user freely available or “public” but keep the decryption key secret. This is a more commercially viable model but still creates a key distribution issue. This has led to development of a hierarchy of trust within the context of the Public Key Infrastructure (PKI), wherein a master authority certifies regional authorities, who may in turn certify authorities at lower levels within a hierarchical structure. A lower level authority may then publish public keys, issue certificates, and verify digital signatures. One party may accordingly acquire a “digital credential” from this authority for use in establishing its identity and credentials to a third party. Public keys may also be issued by a “third party” within an organisation to a party seeking authentication to interact securely and whilst not an external authority to the organisation is nonetheless still a “third party” to the party requiring authentication, whether that be a private individual or a person acting in a defined role.

However PKI has serious deficiencies: it relies upon flawed and obsolete technology. CAs have been hacked, have issued certificates to a person in the name of a different person or legal entity allowing them to masquerade as somebody other than they are, so that certification is not valid. Further, the mechanism for revocation of certificates may be invalid and in many cases is not implemented correctly. The PKI model whilst potentially suitable for key management when originally designed has been used as a platform for identity management for which it is entirely unsuited given its design does not readily replicate the physical world. There are many documented examples of both government and commercial keys falling into the hands of other parties either as a result of poor process, inadequate control or fraud, as illustrated in the detailed legal analysis by Stephen Mason, Electronic Signatures in Law (3rd edn, Cambridge University Press, 2012)

Problems with the mechanisms described above is that they treat one party with fewer or different rights than the other; they assume the subordinate party cannot be trusted but the superior party can; offer little or no protection to the subordinate party in cases where the superior party is impersonating or ‘spoofing’ the identity of the genuine party; and, assume this single approach satisfies the risk mitigation needs of all transactions whether they have no value or are valued in millions.

US Patent Application US-A-2011/0154037 discloses a method of authentication of transmissions between a sender and receiver, wherein each has an associated trusted master device, which distribute appropriate keys to sender and receiver to enable communication, upon fulfillment of communication conditions. In addition sender and receiver each has a unique identity based on a random number, “id” of the communication device, and “references” provided by a “witness” or third party, which is required to overcome the limitations of the Transmission Control Protocol/Internet Protocol (TCP/IP) model. The third party may be selected from a group of network devices that have previously been in communication with both sender and receiver. A problem with this method is that of having to rely on master devices or groups of other devices that have previously been in communication with sender and receiver, which link between the technology and the human being: that is, a connection between the legitimate person and their certificate. This approach accordingly suffers the same drawbacks and flaws as the PKI approach.

US2007/118877 describes a concept which enables the role a person might have (for instance, CEO or supervisor) to be made explicit when employing the concept. The role is determined through the use of PKI and the issuing of a credential by a third party. This concept requires the use of a portal server and a number of trusted authorities (also called certification authorities) between the users of the system. The certification authority acts to verify the credentials of the participants and uses PKI, associated trusted authorities and certificates, and a content management system. Nonetheless, this approach still is fundamentally dependent on the PKI approach with its inherent flaws.

WO 02/067099 describes a method of enforcing authorisation in shared processes using electronic contracts. There is no trusted third party to provide a common rooted key hierarchy however the process still relies on public keys to verify that requested action corresponds to identified terms and conditions of a shared process or to verify adherence to an electronic contract.

We have now devised a method, infrastructure and mechanism which enables secure communication and authentication between two or more objects or parties without any intermediary or certification or validation and which does not require or rely on a public key. The parties interact directly and provide requested credentials to the other one or more parties appropriate to the circumstances and the nature of the interaction and each party determines for itself whether to trust that the other party has provided sufficient evidence to prove its identity. This approach provides a structure for communication, transactions and other interactions between parties which is “flat” in that the interaction and authentication of identity of the parties does not depend on a superposed authority from a third party such as a certification authority as in the conventional hierarchical approach and the risks associated with a party claiming a false identity may be ameliorated by each party determining according to its own approach to risk and having regard to the nature of the interaction, the level of authentication it requires for any given interaction.

### SUMMARY OF THE INVENTION

In its most general aspect, the invention provides an infrastructure for the enablement of communications between two or more objects within said infrastructure. The infrastructure may be referred to herein as a trusted framework. In order to gain access to and to operate within the trusted framework, a user or an “object” as defined herein must be identified and authenticated to the satisfaction of a second user or object and suitably in relation to a particular role the object is to perform. Upon establishing these credentials as between two or more users or objects, processes may then be carried out between the users or objects in a secure environment.

The term “object” as employed herein means any person including a real person and a legal person or entity, company or organization, person acting within a determined role, person acting within a determined role within an organization, or technical means, for example an electronic article, software, for example a software application, or hardware, for example a data processor device. Where a processor is under the control of an object, this implies that the object has responsibility for the processor and that the processor is associated with the object, whether or not the object is physically engaged in operating the processor at any particular time. The terms “actor”, “user” and “party” are also used herein and are intended to be coextensive in meaning with “object” unless the context requires otherwise.

Within this infrastructure, the invention suitably comprises:

a mechanism for determining the nature of the relationship between objects, for instance master/slave;

a mechanism for the naming of an object, preferably as set forth in any one of the preferences 2 and 23 to 51 hereinbelow set out;

a mechanism for the authentication of an object, preferably as set forth in any one of the preferences 3 and 52 to 62 hereinbelow set out;

a mechanism for the discovery and/or location of an object, preferably as set forth in any one of the preferences 4 and 63 to 77 hereinbelow set out;

a mechanism for enabling two objects to communicate one with the other, preferably as set forth in any one of the preferences 5 and 78 to 113 hereinbelow set out;

a mechanism for recording interaction between objects, preferably as set forth in any one of the preferences 6 and 114 to 123 hereinbelow set out;

a mechanism for managing tasks undertaken by objects, preferably as set forth in any one of the preferences 7 and 124 to 136 hereinbelow set out;

a mechanism for signing an object, preferably as set forth in any one of the preferences 8 and 137 to 147 hereinbelow set out;

a mechanism for managing safeguarding data passed between objects, preferably as set forth in any one of the preferences 9 and 148 to 188 hereinbelow set out;

a mechanism for creating an explicit relationship between objects, preferably as set forth in any one of the preferences 10 and 189 to 217 hereinbelow set out;

a mechanism for managing a role for an object, preferably as set forth in any one of the preferences 11 and 218 to 249 hereinbelow set out;

a mechanism for defining rules, preferably as set forth in any one of the preferences 12 and 250 to 288 hereinbelow set out;

a mechanism for assigning rules to tasks, preferably as set forth in any one of the preferences 13 and 289 to 291 hereinbelow set out;

a mechanism for assigning rules to objects, preferably as set forth in any one of the preferences 14 and 292 to 294 hereinbelow set out;

a mechanism for assigning rules to roles, preferably as set forth in any one of the preferences 15 and 295 to 297 hereinbelow set out;

a mechanism for assigning rules to a relationship, preferably as set forth in any one of the preferences 16 and 298 to 301 hereinbelow set out;

a mechanism for storing and retrieving of configuration data, preferably as set forth in any one of the preferences 17 hereinbelow set out;

a mechanism for measuring activity between objects, preferably as set forth in any one of the preferences 18 and 302, 303 hereinbelow set out;

a mechanism for recording measured activity between objects, preferably as set forth in any one of the preferences 19 and 304 hereinbelow set out;

a mechanism for assessing trustworthiness in a given interaction, preferably as set forth in any one of the preferences 20 and 304 to 310 hereinbelow set out;

a mechanism for verification of a name, preferably as set forth in any one of the preferences 21 and any one of the preferences 312 to 329 hereinbelow set out and

a mechanism for extending the function of the infrastructure, preferably as set forth in any one of the preferences 22 and 330 to 345 hereinbelow set out.

The preferences referred to above are listed and numbered for ease of reference and identification at the end of this description.

The invention provides advantage over known computer networks and the public internet by reducing or removing points of vulnerability in systems, and rendering obsolete the need for protocols, elements and technologies in standard use. The invention enables authentication and secure communication or interaction or other process between identified objects without the use of a public key. No third party authentication, whether from a certification authority or any other body or individual, is required in order to enable secure interaction with a third party. The parties themselves exclusively determine their respective identities to the satisfaction of the other party employing credentials appropriate to the circumstances and the nature of the interaction being entered into.

Where in this specification reference is made to the “naming” of an object, this term includes identifying an object, for example in the case where the object is not a person or labelling an object.

The infrastructure is dependent on having two or more “protected endpoints”. A protected endpoint as employed herein is under the control of an object and is a point of access into the trusted framework or the infrastructure. It is necessary to identify a protected endpoint under the control of a first object to the satisfaction of a second object with whom or which the first object will engage in a process, transaction or other interaction. A protected endpoint may be a processor device or user interface.

The invention further provides a network of protected endpoints for transmission or exchange of digital data, the network including first and second protected endpoints each protected endpoint being under the control of a respective first and second object, and configured for messages, preferably encrypted and digitally signed, to be transmitted therebetween including a mechanism for mutually asserting the identity of a person or object as part of a digital transmission or exchange over the network between the first and second protected endpoints, preferably devices, wherein each object has a plurality of data items in a database relating to the identity of the object, wherein each said item is independently verifiable by a respective third party which third party is different for each item of said plurality of data items and wherein a digital transmission or exchange between said objects includes as a preliminary step exchange of an amount of data contained in each objects database, so as to verify identity of each object by the other object to a desired degree.

The invention also provides a method for mutually asserting the identity of a person or object as part of a digital transmission or exchange over a network of devices comprising:

providing a first and second protected endpoint which are connectable to provide a network of protected endpoints for exchanging digital data, each protected endpoint being under the control of a respective first and second object and configured to transmit messages, preferably encrypted and digitally signed, between the first and second objects;

providing a mechanism for mutually asserting the identity of the first and second objects as part of a digital transmission or exchange over the network between the first and second protected endpoints, preferably devices, wherein

each object has a plurality of data items in a database relating to the identity of the user, wherein each said item is independently verifiable by a respective third party which third party is different for each item of said plurality of data items and wherein

providing a digital transmission between the first and second objects which includes as a first step exchange of an amount of data contained in each objects database, so as to verify identity of each object by the other object to a desired degree.

The object is preferably a person or user.

Reference to “messages” herein may include transmission of any material, whether a message, data, or other material and include a transaction or any form of interaction between the protected endpoints.

The “desired degree” to which identity may need to be verified will be determined by the objects dependent on the nature of the intended interaction or transaction and the wishes of the object or rules under which an object may operate.

In a preferred embodiment the items of data are held in one or more encrypted databases under the direct control of the respective parties, the database including one or more of identity data, role data, relationship data, reference data, audit data, task data and rules.

Suitably the databases are encrypted and the records therein may also be encrypted and some parts more than once, the management of this being controlled by one or more rules.

The databases may be split into a number of parts whether equally or not equally. The databases or a part thereof may be stored in different places. Additionally, for further protection of the contents, or for convenience, the elements may be distributed across a network, but still be encrypted in a known manner or in a manner devised in the future. The location of the respective parts is known only to the relevant object.

The invention also provides a network of protected endpoints for transmission of exchange of digital data, the network including first and second protected endpoints, each protected endpoints being under the control of a respective first and second object, which may send messages, preferably encrypted and digitally signed, therebetween

including a mechanism for creating, managing, assigning and enforcing rules as part of a digital transmission or exchange over the network between the first and second protected endpoints, preferably devices, wherein each object has a plurality of data items in a database relating to the identity of the object, wherein each said item may be independently verifiable by a respective third party which third party may be different for each item of said plurality,

and wherein a digital transmission or exchange between said objects includes as a preliminary step configurable handshaking to match security level to the level of risk acceptable and security policy of the interacting objects.

The invention also provides a method for transmission of exchange of digital data of a network, the network including first and second protected endpoints, each protected endpoints being under the control of a respective first and second object, which may send messages, preferably encrypted and digitally signed, therebetween comprising

creating, managing, assigning and enforcing rules as part of a digital transmission or exchange over the network between the first and second protected endpoints, preferably devices,

providing for each object a plurality of data items in a database relating to the identity of the object, wherein each said item may be independently verifiable by a respective third party which third party may be different for each item of said plurality,

providing a digital transmission or exchange between said objects comprising as a first exchange a configurable handshaking to match security level to the level of risk acceptable and security policy of the interacting objects.

The term “configurable handshaking” as employed herein means establishing a connection between the interacting objects with a level and method of security that is agreed between the objects so each object has a means of verifying the identity or credentials of the object to a degree that is required by that party having regard to that party's attitude to risk, policy or other criteria. Suitably, the content of the interaction can be read equally by both objects but kept confidential and secure from other objects.

The invention also provides a network of protected endpoints for transmitting or exchanging digital data, the network including first and second protected endpoints, each protected endpoint being under the control of a respective first and second object, the network being configured to enable messages to be transmitted between the first and second protected endpoints, the messages preferably being encrypted and digitally signed

and including a security management mechanism for managing security issues arising from transmission of digital data, wherein the mechanism includes stored data comprising each object having stored in digital form a plurality of data items in a database relating to the identity of the object, the role of each object is defined in digital form to the satisfaction of the other object, a set of rules defined, preferably in digital form, to regulate transmission or exchange of data between the first and second protected endpoints. Suitably, the set of rules includes technical requirements and also rules relating to the form of digital data.

The invention also provides a method of managing security arising from transmission or exchange of digital data over a network, the network including first and second protected endpoints, each protected endpoint being under the control of a respective first and second object, the network being configured to enable messages to be transmitted between the first and second protected endpoints, the messages preferably being encrypted and digitally signed, said method comprising:

providing a security management mechanism for managing security arising from transmission or exchange of digital data, wherein the mechanism includes stored data comprising each object having stored in digital form a plurality of data items relating to the identity of the object in a database;

defining a role of each object in digital form to the satisfaction of the other object, providing a set of rules defined, preferably in digital form, to regulate transmission of data between the first and second protected endpoints

In a further aspect the invention provides a process for managing security across a network of protected endpoints, the network including first and second protected endpoints, each protected endpoint being under the control of a respective first and second object, which may transmit or exchange messages, preferably encrypted and digitally signed, therebetween, the process comprising:
each object defining in digital form items of data establishing the users identity;
each object, preferably party, defining in digital form the nature of the relationship to be established with another object, preferably party, the role of the object within that relationship, and rules to be applied for interaction, for example the carrying out any transactions, between the first and second objects,
and the each object transmitting or exchanging with the other object communications across the network to establish identity to the other object's satisfaction, and to agree said role and rules, whereby to establish an agreement governing interaction between the objects and the objects subsequently carrying out interactions within the limitations of the agreement.

The present invention further provides in another aspect a mechanism for trusted communication, for example a security mechanism for a computer network, the network including first and second protected endpoints, the first protected endpoint being under the control of a first object, the second protected endpoint being under the control of a second object and the first and second objects wishing to interact, preferably communicate or carry out a transaction, said first and second protected endpoints being coupled to a configuration file means, said configuration file means specifying the conditions under which interaction may take place between said first and second protected endpoints, and the configuration file means including identity data of the first and second objects, to be exchanged between the objects, the identity data including one or more reference items of identity reference data, and the configuration file means defining the type and amount of data safeguarding which is employed.

The invention also provides a method of communicating securely over a network to establish trusted communication, for example a security mechanism for a computer network, the network including first and second protected endpoints, the first protected endpoint being under the control of a first object, the second protected endpoint being under the control of a second object and the first and second objects wishing to interact, preferably communicate or carry out a transaction, said method comprising:

providing configuration file means which specifies the conditions under which interaction may take place between said first and second protected endpoints and which configuration file means comprises identity data of the first and second objects to be exchanged between the objects, the identity data including one or more reference items of identity reference data, and the configuration file means defining the type and amount of data safeguarding which is employed;

coupling said first and second protected endpoints to the configuration file means;

transmitting or exchanging between the first and second protected endpoints identity data under the specified conditions and in accordance with the defined type and amount of data required to establish the identity of one objects to the satisfaction of the other object. In one embodiment, the network may include one or more audit mechanisms which may or may not be in the possession of a third party for providing independent verification of the actions of the objects.

In a further aspect, the invention provides a method of carrying out secure communication in transactions between first and second objects in a computer network, the network including first and second protected endpoints, the first protected endpoints being under the control of the first object, the protected endpoints device being under the control of the second object,

the method comprising forming a relationship between the first and second objects, by each object exchanging preferably in digital form identity data with the other to a degree that satisfies the other object, the identity data which may include one or more items of reference identity data, and the network optionally including one or more audit mechanisms for providing independent verification of the reference items,

agreeing between the first object and second object data safeguarding procedures to be carried out, and

providing a configuration file means which is used to regulate transactions between the first and second objects and which specifies the conditions under which communication transactions may take place between said first and second protected endpoints, the degree of identity data to be exchanged between the objects, the reference data required, and the type and amount of data safeguarding employed.

The safeguarding procedures may include for example encryption, where to store data, how to store data and authentication procedures.

The “degree” of identity data may include for example the amount of data and the type of data and will be determined by the object seeking confirmation of the identity of another object.

Thus, in transactions between said first and second objects across the network, said configuration file means is used to manage the various aspects of the establishment of two way communications.

For the purposes of the specification, “data safeguarding” is intended to include any measure for keeping data confidential and/or authenticated, and includes digital authentication, encryption, maintaining data in the custody of a trusted third party, and keeping data in safe locations, for example by splitting a file and storing different parts in different locations.

Embodiments of the invention mimic in electronic form a physical world situation of forming a relationship with another person, and then making an agreement under which interactions can be conducted. In one embodiment, a configuration (control) file means may form the basis of a legally binding agreement, and in addition to specifying technical requirements may include all legally binding Terms and Conditions of an agreement, preferably expressed in an XML record. Each object may have a copy or version of the agreement in its possession. Desirably the first and second protected endpoints each have associated respective first and second data stores, which contain a copy of the configuration file means. In the preferred embodiment, measures are taken to safeguard the databases, as described below.

When building a new relationship in the physical world, firstly there is identification of each party to the satisfaction of the other party. Then we often ask for one or more references to verify a claim of some sort. This could be a license to practice, a membership of a professional body, the absence of criminal record or simply confirming an employment history. Each reference data item that is stored can be verified separately by one or more third party. This is in the control of the object owner, but may be at the behest of another party with whom they are building a relationship, and it is for the other party to decide whether the third party verification has sufficient evidential weight for their purposes. Thus if a claim is made to be a medical doctor, a reference from a next door neighbour is likely to be insufficient in most cases, but if the claim is to be a goalkeeper in a local soccer club that might well suffice. In the physical world, if a request is made for a driving license as proof of identity, it might be necessary to ensure that it has not been tampered with or fraudulently created. In the present invention we give the second party the ability to go to the provider of the reference (for example a professional or regulatory body) with the permission of the first party and verify authenticity. It should be noted that references may or may not be provided solely in electronic form. Should the second party be satisfied by a paper-based reference, then in the preferred embodiment this is acceptable and the receipt of said reference is recorded and treated in the same manner as if it were provided electronically, save for the real-time verification.

Suitably, in embodiments of the invention, each said data store is stored based on rules set out by the owner and contains data belonging to the owner. In the case where the individual is, say, an employee of a company, it may hold data about the role, but not the company's own data or that of a customer etc. Each database is suitably encrypted at least once and some parts more than once. The database may be split into a number of parts (and not equally) and stored in a variety of places chosen by and under the control of the owner.

In a preferred embodiment, configurable handshaking is carried out to match the security level to the level of risk and security policy of the interacting parties. The user or user organisation specifies, based on a given process and level of risk, how their various security options are configured and how a process is managed. Examples of this could be when using internet banking the SHA256 encryption must be used, or when buying a national lottery ticket the purchaser must be 16 year or older and be UK resident. By allowing the parties to a transaction to specify security options, this places control in the hands of the parties, and takes away control from IT systems, which may not be appropriate tools for determining security features.

In one embodiment, the infrastructure and network according to the invention enables the use of trusted software between objects, particularly parties or people within a trusted framework. This embodiment provides a mechanism for a first party to transmit to a second party an electronic file containing information, for example a document in any context. This mechanism is suited to use in a commercial environment or a private or personal context. The electronic file preferably comprises any type of document and may include electronic ‘letters’, invoices, purchase orders, bank statements, payroll slips or any other document where authenticity is of importance to both parties. The mechanism enables confidentiality to be ensured and may provide a guarantee of delivery to the intended party.

In this embodiment, the trust framework established by the invention enables correspondence to be transmitted without the need to manage identity, authentication, relationships, permissions, encryption and the like. By defining appropriate rules in the trust framework complexity may be reduced, and development to enhance or change functionality of software or the need to write new software may be reduced or avoided.

Once a party has been identified and authenticated and is within the trusted framework, a range of rules may be provided to define and delimit the types of activity that a party may engage in whilst using the software. Examples of rules which may be tailored to a particular party or to a defined role within an organization include:
a) A party, where an explicit relationship with said party exists within the trust framework, can be a recipient, providing one or more business rules don't prevent it;
b) A party, acting in a role of employee, may be allowed/not allowed to copy another party on correspondence;
c) under the control of one or more business rules a party may be allowed/not allowed to copy a document to another party where an explicit relationship exists;
d) under the control of one or more business rules a party may be allowed/not allowed to copy a third party (equivalent to ‘cc’) but to restricted list based on role;
e) under the control of one or more business rules a party may be allowed/not allowed to forward correspondence to one or more third parties;
f) under the control of one or more business rules a party may be allowed/not allowed limit further forwarding by the third party;
g) under the control of one or more business rules a party may be allowed/not allowed restrict who doc can be forwarded to based on role;
h) under the control of either one or more business rules a party may protectively mark correspondence (confidential, restricted, etc.) either in whole or in part. Where the document is marked in part, different parts may have different markings;
i) under the control of one or more business rules a party may be allowed/not allowed custom marking of correspondence;
j) under the control of one or more business rules a party may be allowed/not allowed to organise the way in which correspondence is stored for later search and retrieval. This might include use of ‘tags’, for example Topic, Date, Recipient, Ref Your/My, Sender, Account or other identifier, Protective marking;
k) under the control of one or more business rules a party may be allowed/not allowed to select from a list of one or more possible options, a template on which the correspondence may be based. Examples of such templates might include Note, Memo, Standard letter, Purchase order, Invoice, Payment instruction;
l) under the control of one or more business rules a party may create a template thereby reducing the time take to format a document but also ensuring the needs of the organisation in areas such as company law and regulatory compliance are met. The XML (for example) template has one or more ‘zones’ for variables/text/images, for example:
m) the company logo/branding, reference(s), date, text, statutory text, correspondence address, cc list
n) under the control of one or more business rules a party may be allowed/not allowed to generate ‘bulk mailing’ of correspondence. This might include:
   i) ability to select a group of relationships by some form of query and mail merge using the correspondence app;
   ii) apply business rules and any restrictions that apply based on the role of the party as would be the case with a single ‘mailing’;
   iii) capture of errors/rejections in attempting to generate multiple separate correspondence;
o) under the control of one or more business rules a party may be allowed/not allowed to view various information that might be of use in tracking correspondence or settling a dispute. Examples of this might include:
   i) Proof of delivery;
      a) proof of technical delivery e.g. the sending and receiving computers both confirm sending and receiving of the correspondence as distinct from the second party opening or viewing the correspondence;
      b) proof of delivery by signing e.g. the second party confirms receipt of the correspondence by signing for receipt;
      c) proof of acceptance of content by single signing e.g. the second party signs to accept the content of the correspondence as distinct from accepting receipt;
      d) proof of acceptance by multi-signing e.g. one or more parties, say directors of a company, may sign to accept the content of a document such as an insurance proposal form;
      e) proof of acceptance other act by signing;
      f) proof of signing and signature witnessing e.g. the second party accepts the content of a document and a third party witnesses the signature of the second party;
   ii) Proof of opening
   iii) Proof of forwarding including the information relating to the party to who it was forwarded;
   iv) Proof of printing including the device that was used to print;
   v) Proof of delegation;
   vi) Proof of time lock opening e.g. as might be the case with a response to a tender document;
   vii) Proof of signature for other purposes;
p) under the control of one or more business rules a party may be allowed/not allowed to recall a document that has not been opened by the second (receiving) party;
q) under the control of one or more business rules a party may be allowed/not allowed to set a lock on the correspondence e.g. not to be opened before/after a certain time/date;
r) under the control of one or more business rules a party may be allowed/not allowed to mark one or more sections of the document;
s) under the control of one or more business rules, the software application may generate a metering and billing record and pass it to the trust framework for later charging of one or more parties;
t) It may be desirable for the application to differentiate between private user and commercial user and thereby restrict functionality based on need and/or whether a paid or free of charge software license has been signed.

### BRIEF DESCRIPTION OF THE DRAWINGS

Embodiments of the invention will now be described by way of example and with reference to the accompanying drawings in which:

FIG. 1 is a schematic view of symbols used in these drawings, together with a textual explanation;

FIG. 2 is a schematic diagram of an initial process of authentication for one embodiment of the invention for creating a binding transaction between two parties;

FIG. 3 is a schematic diagram of overall process of the embodiment of FIG. 2;

FIG. 4 is a schematic of a process for creating a digital identity which is stored in a database, for the embodiment of FIG. 3;

FIG. 5 is a schematic of part of the process of FIG. 3 for establishing references verifying identity;

FIG. 6 is a schematic of a second embodiment of a digital process in which an employer offers a person a role within the employer's organisation;

FIG. 7 is a schematic of an application of an embodiment for a meter billing application;

FIG. 8 is a schematic of an extension of the embodiment for allowing third parties to develop applications;

FIG. 9 is a schematic of entities in the infrastructure of an embodiment and their relationships;

FIG. 10 is a schematic showing the principle of striping of a data base;

FIG. 11 is a schematic showing interactions with a reference provider, object and reference requester in validating ID data; and

FIG. 12 is a schematic of safeguarding devices arranged in a mesh to prevent rogue appliances being added to the infrastructure.

### DESCRIPTION OF PREFERRED EMBODIMENTS

Embodiments of the invention maintain security in computer networks by mimicking secure transactions which take place in the physical world, involving identifying and authenticating two parties to a transaction to the extent judged to be necessary having regard to the nature of the intended transactions, making an agreement or legally binding agreement, and then implementing secrecy or confidentiality measures during transactions. Embodiments address the issues of what is needed to operate digitally as in the physical world, where two parties interact with one another to make an agreement. In contrast prior procedures for security in computer network generally operate by imposing a global view on security considerations, to which all users have to conform, i.e. a server or hub-centric system. However such global systems have proved flawed, for example the Public Key Infrastructure (PKI). There are also many examples of simple mistakes, e.g. an encryption key being given to the wrong person, which destroy the security of a computer network.

Preferred embodiments of the invention implement one or more, and preferably all, the following measures:

1. Two network users want to communicate and agree, as a minimum, basic terms under which communication will take place; the end point is a handshake agreement. Two parties, users, actors, or objects are able to interact directly, without a middleman or computer server, which may interfere with or disrupt transactions that may or may not be for malicious purposes.

2. It is not possible to force identity or behaviour on another of equal standing in this interaction, because both have equal rights and responsibilities, and furthermore this supports the objective of ensuring the parties carry their own legal liability. The measures required in any particular instance is agreed beforehand between the objects. Where the parties are not of equal standing (such as where one party is a parent and the other their child), certain things may be forced on one party by the other as this is permitted under law.

3. Embodiments of the invention establish identity and authenticity, and further, the legal role in which each of the parties act, which is of particular use for both business and government in managing legal liability. This is to be contrasted with current systems, which authenticate with passwords or other tokens that permit access to a network but make no such differentiation and neither do they bind the claim of identity to the token being used. Thus the role of a party is important e.g. is the individual the CEO of company or some person as a private individual, in the former case the role has been offered by the organisation and accepted by the individual. Roles within an organisation structure must be explicitly defined. Individuals accepting a role have their personal identity bound to the role enabling auditability and accountability in excess of that usually possible with traditional computer systems.

4. A role, once having been set up, is controlled by the respective manager in the organisation and further by business rules or permissions, e.g. a private person is offered (and accepts) a role as head of purchasing in a bank, then an associated rule specifies the person in the role is empowered to sign agreements up to a value of £10,000 in but only in the UK. The database may store Choices or Business Rules, which are to be applied during transactions between the parties. These are predefined and form part of the agreement. For example, an electronic document correspondence application: a user may type in text and predefined business rules such as letter format or layout. Rules may specify electronic records of said correspondence, and where correspondence is to be stored for later retrieval. Thus, parties determine rules depending on attitude to risk and circumstances rather than having them imposed by a 3^{rd} party. Rules can have a legal validity, but on the basis of an agreement people involving two way offer and acceptance, and in which actors have accepted responsibility.

5. Credentials are used to support the claimed identity of each user in order to build a peer-to-peer relationship. Thus if parties do not know each other, there is a facility to establish credentials i.e. references, e.g. driving licence, which are independently verifiable by the party which originated the reference. A party may be a private person or an employee or official of an organisation with specific role, e.g. head of purchasing with spending authority. Either party may specify reference providers. For example a user may wish to check a company director and check company identity. In this case a check would be made with the appropriate regulating body, for example Companies House, if in the UK. An agreement may specify which references to use, such as a qualification upon which the other party relies. A reference is connected to the reference provider so revocation of authority to act by a governing body (e.g. revocation of a license to practice medicine) is enabled.

Suitably, credentials may only be used once for a given interaction so as to reduce a risk of compromising security. Credentials may be cancelled by the provider.

6. Each user maintains its own, data store, containing inter alia all identification data. The user implements security measures for encryption and storage of the database. The personal database is protected, divided into multiple parts and stored in multiple locations (see FIG. 10). The database is under the control of the party who created it, and who also created the associated encryption keys.

7. Before interacting electronically, the two parties make an agreement that may contain any data agreed by the parties as pertinent to the relationship and their future interactions. Each Actor has a copy of the agreement, which is stored in the respective parties chosen location or locations, which may include in a hardened security device.

8. Regarding technical requirements, data objects within the trust framework, have two elements, firstly the object itself, and secondly meta data defining the nature of the object, control of objects etc. These two elements are stored in separate locations. As regards encryption, symmetric keys are used for an initial authentication process, and then subsequently asymmetric (public) keys may be used for transactions. Each reference may be used as seed for further encryption so select degree of encryption. Identification may include biometric items such as fingerprint records. Tags to keys are encrypted and stored in various locations for example by striping.

9. An independent party, and audit service provider (ASP), may be employed to keep receipts of transmission (audit trail). Such receipts are not accessed or viewed, but are held as a contemporaneous notes of some form of interaction and optionally its contents. Parties who may have a wish to keep their risk low may choose to nominate an ASP for their comfort and protection. The ASPs could optionally be a legally qualified and accredited person, for example a notary public in the UK, regulatory authority or other trusted party.

In the physical world, a notary can start an authentication process by meeting with a person and viewing papers that need notarising. These can be manifest in electronic form and used to support a claim of identity and as such form a reference.

In operation, for example a first party wishing to transmit a letter to a second party, when using a correspondence application within the trust framework will both act in a role, and each will identify and authenticate the other party using their subjective judgement. One party will initiate the dialogue by composing a letter or other such object and transmit it directly to the other party without sending it using commonly used protocols such as the Internet Post Office Protocol (POP3) or the Simple Mail Transfer Protocol (SMTP). By eradicating these flawed protocols, privacy is enhanced, security risks caused by malicious parties impersonating known individuals delivering malware are reduced and other well-documented attacks such as the ‘man in the middle’ attack are eradicated.

Given the flexible nature of the rule set and comprehensive nature of the trust framework, other rules may be encapsulated in applications, such as forwarding rules e.g. The parties are not permitted to forward content to a third party, or certain kinds of content may not be sent to an external party without approval of the specific manager.

The parties to an agreement may be inanimate items or devices such as a motor vehicle or computer system. E.g. car break in and theft is a problem, so we may stipulate within engine management code an agreement that defines rules specify who has permission to operate the vehicle, which is far more sophisticated than a simple key as it may require the person attempting to drive the vehicle to provide on or more credentials. Another example is SCADA devices (sometimes referred to as programmable logic controllers), commonly used for industrial process control. Hacking into SCADA devices is a major threat to national security. One embodiment of the invention would require anyone attempting to operate or instruct a SCADA device to have a valid agreement and explicit relationship with the device before successfully being able to control it. For example, a SCADA device reads business rules to authenticate a person or other device giving it an instruction. If the business rules require a certain approach to identification, authentication or credentials and the person or device is unable to provide them, then the instruction will be ignored.

As another example, the objects may comprise layers of a computer operating system. Thus to communicate with each other, the layers of the operating system have agreed rules for interacting with one another, and communicate according to the rules within the agreement. Should a user of the computer system, either knowingly or unknowingly, attempt to execute malicious code, the trust framework with detect that the code is ‘untrusted’ and will ‘refuse’ to execute it rendering it ineffective.

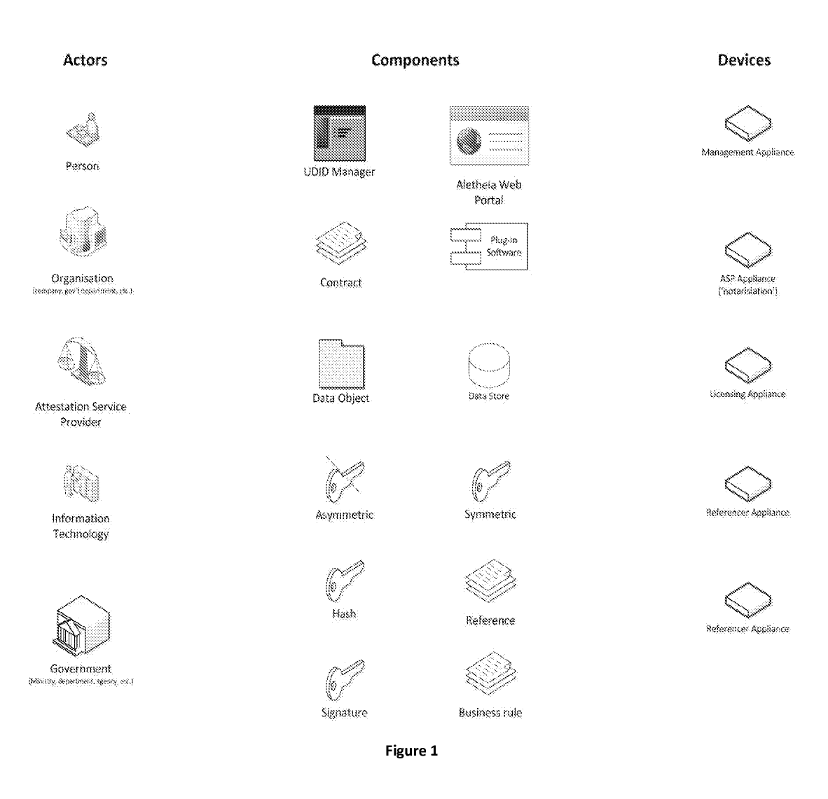

Referring now to the drawings, FIG. 1 shows symbols used in the drawings as follows, and are divided into actors, components and devices. Actors (objects) are users that is people, organisations or technical devices such as software applications which operate protected endpoints for carrying out the embodiments of the invention. Actors include a Person, which is a human being, operating a processor, an organisation such as a company or government department which operates protected endpoints. An Audit Service Provider (ASP) is an independent third party that may provide verification of acts or data, and includes notaries, telecommunication companies, etc. A Government includes departments of a state Government, and agencies thereof. An actor or object may comprise a computer system or software application that carries out a control or regulatory function.

Components include a protected endpoint, which is a device providing access to the trust framework. Plug in software is software developed for a third party that may participate in the present invention.

An agreement is a result of the processes of the invention, and comprises an agreement between two actors, objects or users, and defines a relationship between the two parties. An agreement may be divided into two parts, and the first is analogous to a textual legally binding agreement which sets out the terms and conditions on which two actors may communicate within the processes of the invention. The second part defines the set of rules defining the technical mechanisms for transactions within the present invention, and includes procedures for encryption and authentication of transmissions. The agreement, in particular the technical part thereof, defines a configuration file which regulates processes within the network between the participating actors.

A data object is any item of data which may play a part in the processes of the invention, for example a word processing document, a record of a communication, and comprises two parts, firstly the object itself, and secondly ancillary data defining the nature of the document, type of encryption, etc. These two separate parts of a data object may be stored for security in different locations, e.g. different databases, and may be encrypted.

A data store is employed to hold data which includes all data relating to the identity of a person, and his role in the processes of the invention. The data store may be encrypted and formed into two or more parts which may be stored at different locations.

A symmetric key is a key selected by the user for a symmetric encryption algorithm. Such key has to be stored under conditions of high security. An asymmetric key is employed for public key encryption, and include public and secret keys selected by the user.

A hash for the purposes of the present specification is the result of a hashing algorithm which takes a selected “secret” item of data chosen by the user, and which is then hashed. A hash may be transmitted to another user, who stores the hash. It is part of the proof of identity of the user, since should identity proof be required, the user will supply the hashing algorithm to another user, to enable the “secret” to be recovered.

A reference is an item of data which identifies the user which is verifiable by an independent third party, for example identification data from a passport, driving licence utility bill etc.

A signature is a digital signature prepared according to any desired signature algorithm.

A business rule is an item of data which defines a specific aspect of a user's activities within the procedures of the invention any may for example define a level of encryption to be used in any particular circumstance, or for example where the user is an employee, a definition of permitted activities within the employment role, for example the right to sign off purchases having a value no greater than a specified amount. Business rules may be contained in XML documents.

Devices may be as indicated of different types, and relate to a specific item or items of data and which are contained in encrypted form in a physical device to which is applied electrical and mechanical security measures to prevent tampering. Such items of data may be highly sensitive, and will be described below.

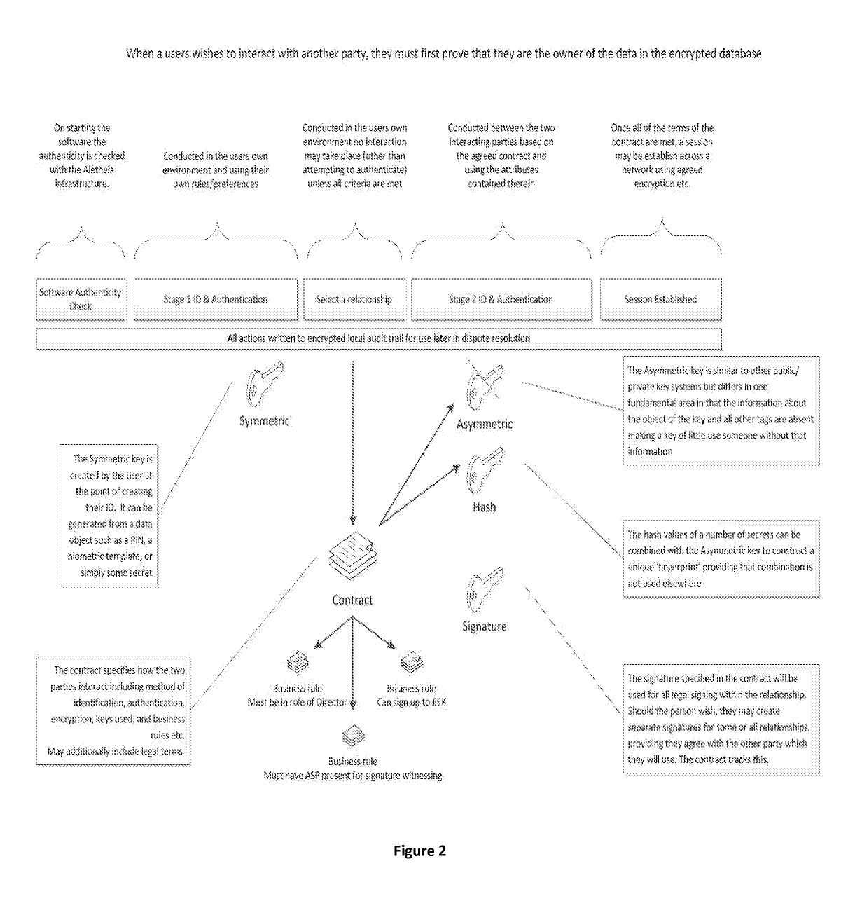

Referring now to FIG. 2, to start a process of the invention, a user has procedures installed within his protected endpoints, PC, laptop, smart phone, tablet etc., which are obtained from and controlled by a web portal of the service provider. The authenticity of the software is checked by the web portal, and each copy of issued software may have a unique identifier.

The party goes through a first stage of identification and authentication, which is carried out within the party's processing environment by himself. The party creates his identification data and the set of rules which will be applied during transactions within the processes of the invention. (In the case of an employee, such rules will be constrained by those conditions set by the employer). In this first stage, a symmetric key is created which is to be employed in a high grade symmetric encryption algorithm. It is essential to keep such key secret. It may be generated from a data item such as PIN, a biometric template, or a secret.

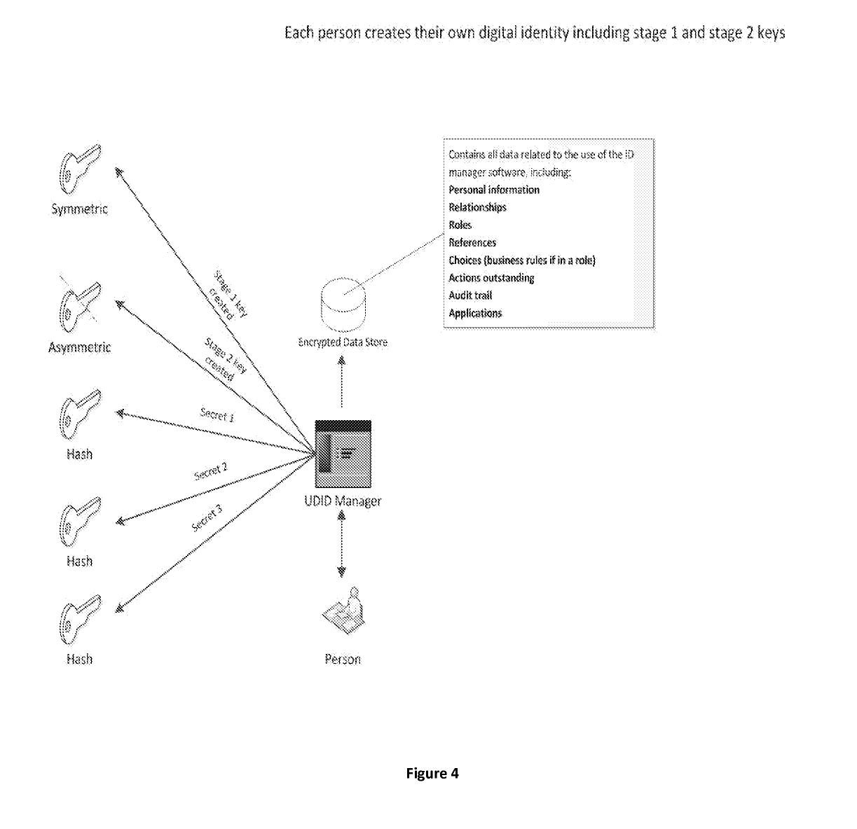

The party then selects a number of items of data which serve to identify and authenticate the party sufficiently for the transactions to be carried out. As indicated in FIG. 4, the process of creating an identity may include selecting secret items of information, which may later be used in authentication. These secrets are subject to a hashing algorithm to generate respective hashes. Such operations are carried out by a protected end-point, which manages the transfers of the results to an encrypted data store. In addition the data store includes relationships, roles to be described below, references (driving licence etc), choices which are applicable to a business employer/employee relationship, actions outstanding, an audit trail, which is an optional item and which identifies for example previous use of the software, and third party applications. The encrypted data serves to sufficiently authenticate the user for the purposes of carrying out the processes of the invention, but does not attempt to be a globally unique identifier, in contrast to prior art procedures.

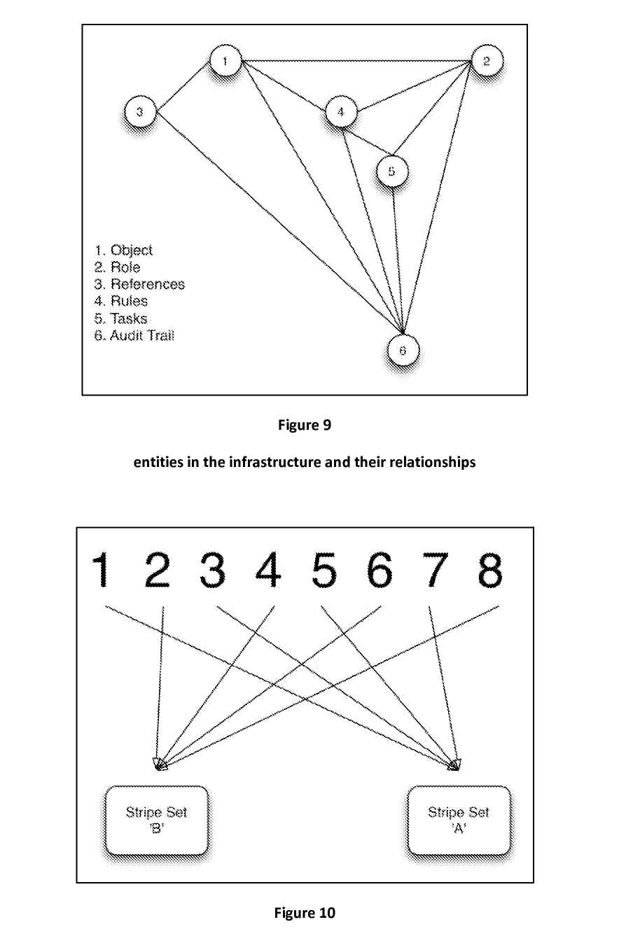

FIG. 9 shows the links or relationships between the various entities in the data store.

In FIG. 2, once a user has defined his identity and authentication procedures, a relationship is selected. This involves another user, and requires a user conducting, in his own environment, selection of the criteria which will define the nature of the transactional relationship of the other party, and which forms the basis of an agreement with another user. The agreement specifies how the two parties interact, including method of identification, encryption, authentication, keys used, business rules, and may additionally include legal terms.

A second user party, who has also gone through similar procedures, may then at this second stage interact with the first user. The two users will exchange data in encrypted form using a public key algorithm using the asymmetric keys provided. However in contrast to known PKAs, data about the object of the key and all other tags are absent, making the key of little use to someone else without this data. Hash values are exchanged representing secrets. If desired these secrets may be combined with the asymmetric key to create a unique fingerprint.

The signature will also be specified which will be used for all valid signings within the relationship. Separate signatures may be created for some or all relationships provided they agree with other party concerned.

Once this data is exchanged, and the terms agreed, then a transaction may take place across the network, using the procedures of the invention for example sending a document file or carrying out a VoIP call.

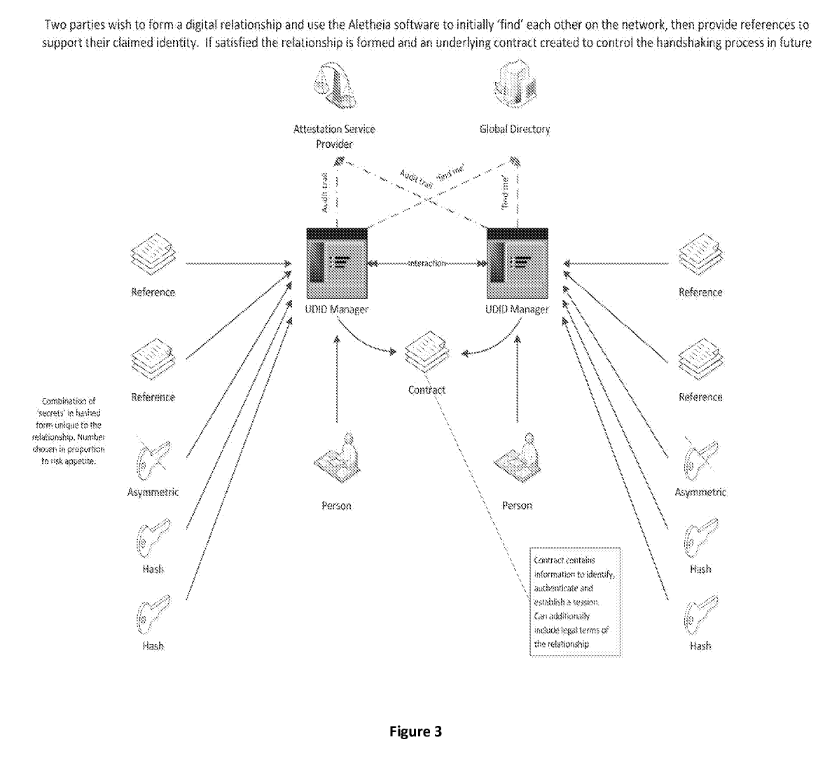

This procedure is illustrated in FIG. 3 in generic terms, wherein two users interact via respective UDID managers, on the basis of an agreement. Each user has as explained above has identifying data, references, hash values, keys. An ASP may provide additional confirmation of identifying data, particularly references. A global directory will provide basic contact data for the two parties.

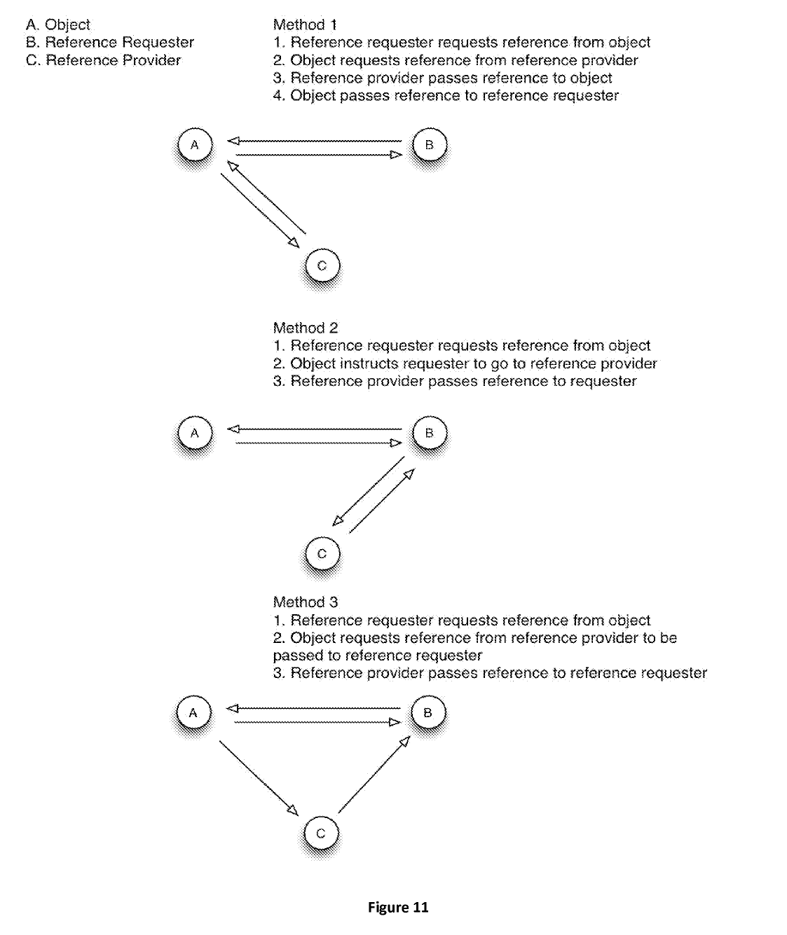

FIG. 11 is a schematic showing various possibilities of interactions with a reference provider, object and reference requester in validating ID data.

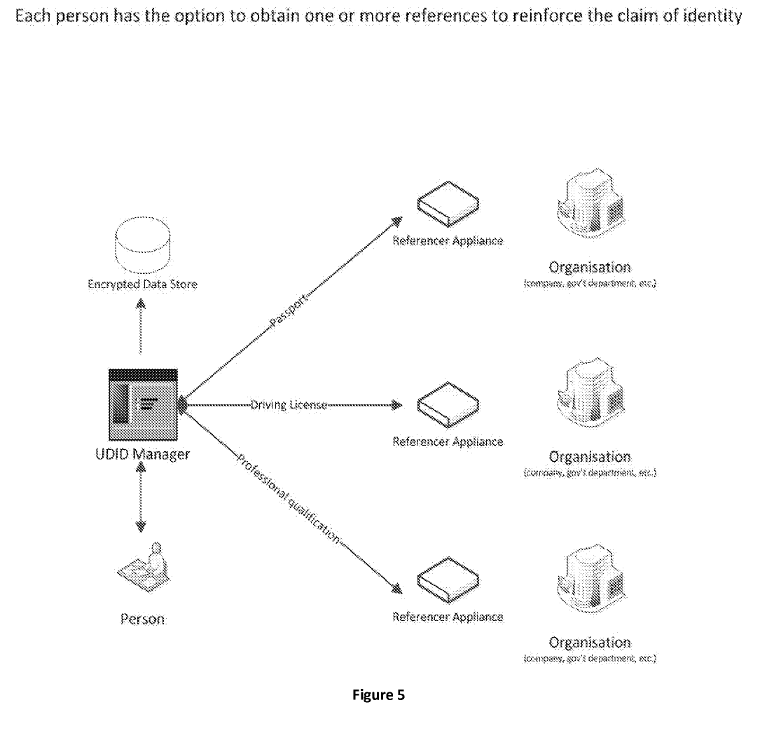

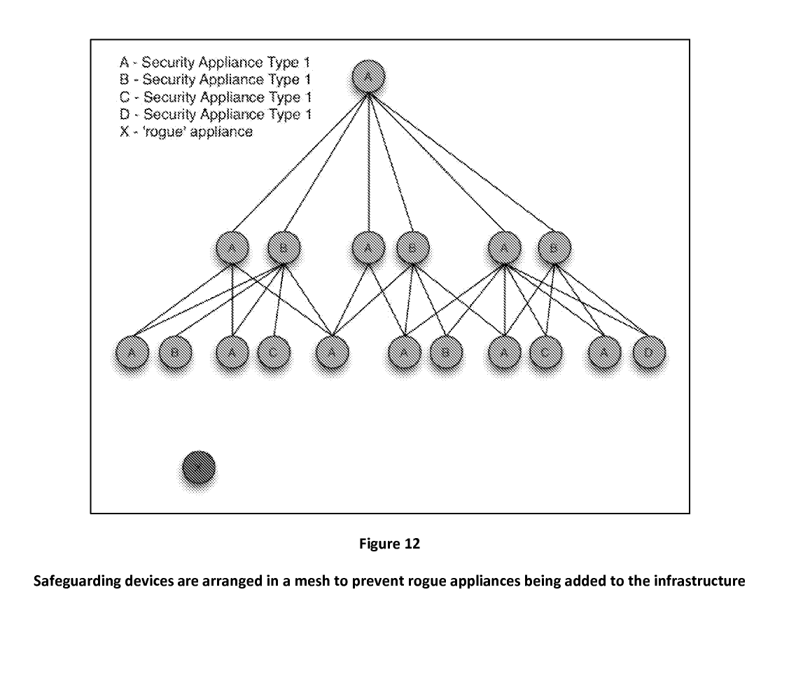

FIG. 5 indicates the references e.g. references issued by recognised organisations, government departments, professional and academic organisations etc. In FIG. 5, these references are thought sufficiently important to warrant separate storage in “appliances”, which are discrete devices, which may have electrical and mechanical security measures to prevent tampering. FIG. 12 shows an arrangement of interconnection of appliances in a mesh to prevent rogue appliances being added.

It will be note that the above procedures for identification and conditions such as security measures for carrying out transactions across a network are defined by the parties involved. This is in contrast to prior art security measures which are imposed globally to all users, but which as pointed out above are subject to serious flows.

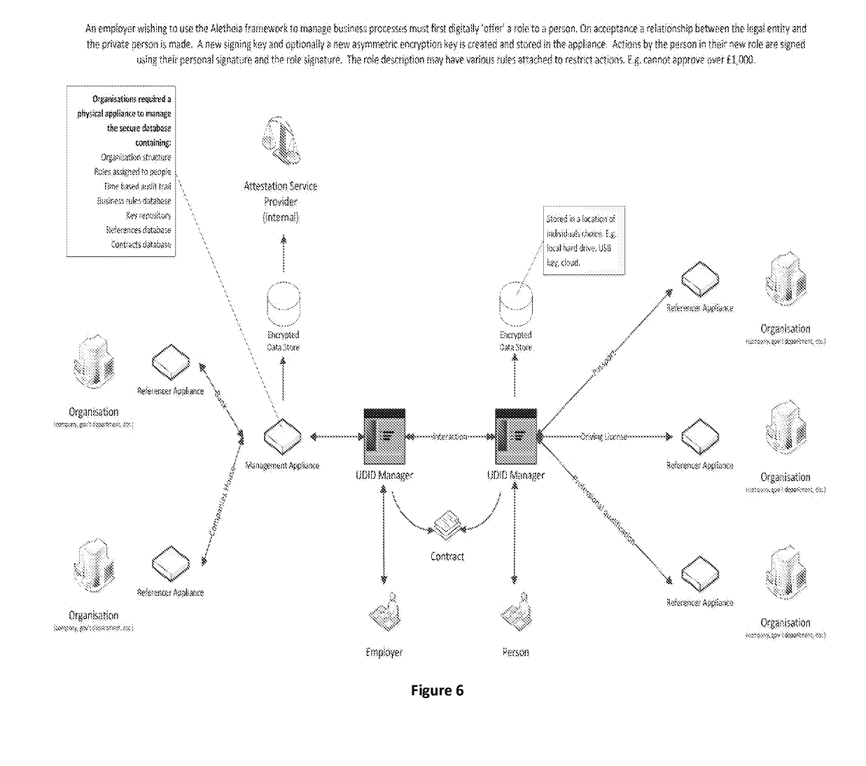

FIG. 6 shows a second embodiment of the invention, in which a potential employee and an employer interact digitally across a network to establish an employer/employee relationship (or agency relationship etc). The processes described above are employed to define a contract of employment, which is legally binding and which includes all necessary rules for conducting the employee relationship. An employer wishing to use the digital framework must first digitally “offer” a role to a user. On acceptance a relationship between the legal entity and the private parson is made. A new signing key and optionally a new asymmetric encryption key is created and stored in an appliance. Actions by a user in this new role are signed using their personal signature and their role signature. The role description may have various rules to restrict actions.

Such a procedure makes use of a firewall in the network unnecessary, because the transactions between the two parties are strictly defined. Thus if an employee tries to obtain data, he must use more than known encryption keys. He must obtain rules for carrying out the transaction, which are the primary obstacle. As indicated, the references for the employer and employee are held in appliances, which are stubs of the identification, and are contained in the device in a secure environment, and which include anti tamper security devices.

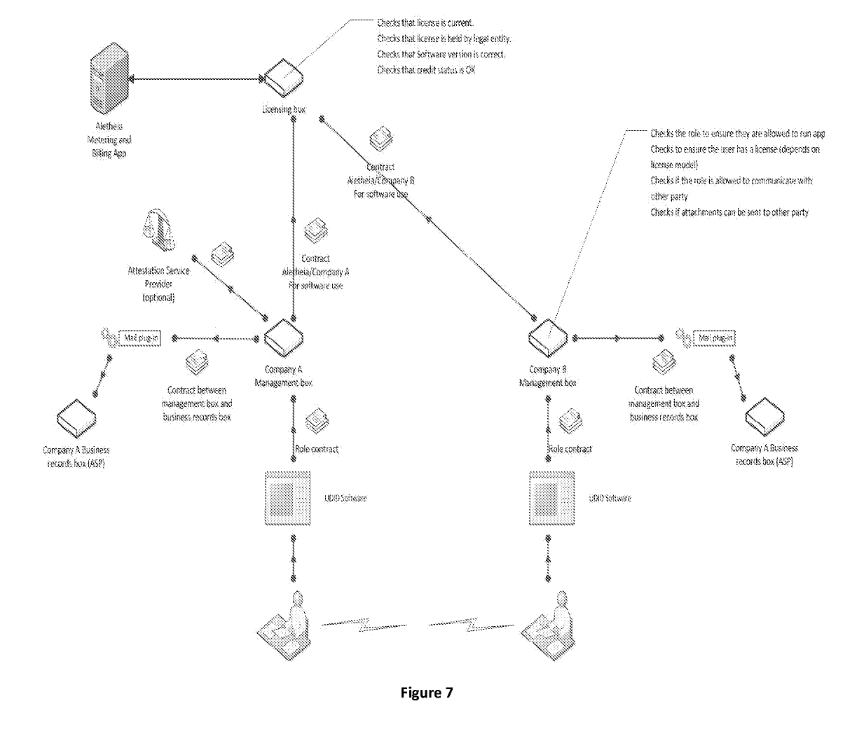

FIG. 7 illustrate a specific application of an embodiment of the invention to a metering and billing operation, e.g. a utility provider.

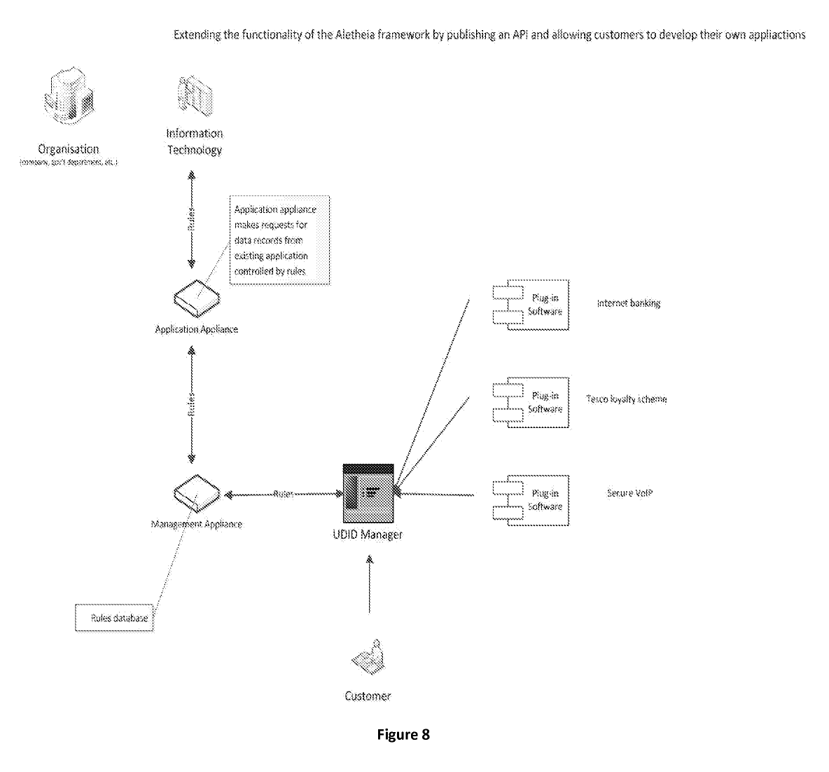

FIG. 8 indicates third party applications which may be installed as add-ons to the embodiments of the invention to enable e.g. internet banking, loyalty schemes, secure VoIP processes.

FIG. 9 is a schematic of entities in the infrastructure of an embodiment and their relationships.

FIG. 10 is a schematic showing the principle of striping of a data base.

FIG. 11 is a schematic showing interactions with a reference provider, object and reference requester in validating ID data.

FIG. 12 is a schematic of safeguarding devices arranged in a mesh to prevent rogue appliances being added to the infrastructure.

Thus features of the invention are as follows:

1. A mechanism for mutually asserting the identity of a person or object as part of a digital exchange over a network of devices;

2. A mechanism for agreeing and asserting agreed terms as part of a digital exchange over a network of devices;

3. A mechanism for creating, offering, accepting, and otherwise managing and visibly acting in a verifiable delegated role as part of a digital exchange over a network of devices;

4. A mechanism for creating, managing, assigning, tracking and enforcing rules as part of a digital exchange over a network of devices;

5. A mechanism for enhancing and strengthening a claimed identity in a digital exchange over a network of devices to the level of risk accepted and agreed by the interacting parties;

6. A technically an legally robust platform for providing evidential weight audit data as part of a digital interaction;

7. A mechanism for combining an unique pattern of data objects to provide and allow the verification of a claimed identity;

8. A mechanism for full life cycle control and traceability of a data object;

9. A mechanism for providing a legally and technically robust platform for interoperability between disparate and geographically separate parties in different legal jurisdictions.

The invention as set forth above provides following functions:

Overall difficulty in ‘breaking’ security in the framework of the invention.

The framework of the invention does not force choices on the user, making it difficult for a hostile party as they cannot assume how security is configured, examples include choice of encryption algorithm and Identity related data storage.

Difficult to assume the identity of a person or object fraudulently.

Design of the framework is explicitly intended to make it difficult for a hostile party to take control of the identity of an individual of an object.

Symmetric encryption key to encrypt the data store driven by user choice rather than system choice makes an attack by a hostile party more difficult.

In most cases, a computer software application design assumes that a person who has access to that application has no hostile intent. The design of the framework takes the opposing view, which is, that cannot be assumed.

Access to the software in the framework cannot be achieved without passing the initial authentication step, which is set by the owner for their own benefit and protection. This step is analogous to using a key to open the door of a house; the owner is legitimate but others wanting to open the door may not be, so the owner chooses what type of lock or combination of locks mitigates the risk.

User may choose one of a number of methods of generating a symmetric key.

The data required to manage the digital identity is a potential target for a hostile party so its security and integrity is a high priority. One of the methods used to protect the data is to encrypt it.

Unlike many other methods of managing encryption, such as PKI, the security of the key is paramount. Given the number of incidents where key generators/providers (known as Certification Authorities) have been compromised, self-generation of keys is desirable if not essential. This is also an issue in claiming evidential weight of data should another party have access to keys, as in the case of PKI.

Examples of choices that a user might have when generating the symmetric key might include:
A personal identification number (PIN)
A passphrase or string of characters
A biometric token of some kind
Selecting an image from a large number of possible images

Symmetric key is generated using the choice of data as a seed to generate the key. User is protected should the key become comprised as a new key may be generated and the data store re-encrypted.

By allowing the owner the choice of how and where data is stored, a possible attack is made significantly more difficult.

In other approaches to the management of security data, the software manufacturer by convention makes many of the choices for the user, including where and how the data is stored. This data tends to be published, and generally will include the name of the file in which the security data is stored, its location and sometimes even its format. This is of significant benefit for a potential hacker, and is akin to finding.

Striping of the data: Prior to storing the data it is split into ‘stripes’ with alternate stripes being encrypted and then stored in different locations (FIG. 10). Should a hostile party gain access to one of the encrypted data portions, they would need to discover the key required to decrypt it, but this would unlikely to yield much useful information due to the striping.

Encryption of the data. All data in the system is encrypted using the choices made by the owner of the data. A hostile party cannot assume that, by inspecting the software and his/her own use of it, that another party will have chosen to use the same approach. These choices include encryption algorithm, encryption strength, encryption key used, signature used etc.

Certificates: The X509 standard specifies, among other things, the format for public key certificates used in a PKI infrastructure. The standard has a significant weakness, in that it requires a collection of meta data to be contained within the certificate. A hostile party can use this information to make use of the certificate for unauthorised purposed. This is akin to finding a door key in the street with the address of the property to which it relates. The design separates the key itself from its meta data making a randomly found or stolen key of little or no use to the ‘finder’.

The design specifies that all interactions between parties are directly between them with no ‘middle man’ or server involved where data could be read, copied, altered or subverted in some way.

The framework design ensures that the infrastructure is merely a mechanism for secure communications, with no data being visible on the part of the infrastructure operator.

The invention suitably comprises one or more preferences as listed below. The preferences are numbered for ease of reference and identification and the order in itself does not imply any greater or lesser importance of any of the preferred features.

Preferences for the invention are as follows:
1. An infrastructure for the enablement of communications between two or more objects within said infrastructure.
2. An infrastructure according to preference 1 including a mechanism for the naming of an object.
3. An infrastructure according to preference 1 including a mechanism for the authentication of an object.
4. An infrastructure according to preference 1 including a mechanism for the discovery of an object.
5. An infrastructure according to preference 1 including a mechanism for enabling two objects to communicate one with the other.
6. An infrastructure according to preference 1 including a mechanism for recording interaction between objects.
7. An infrastructure according to preference 1 including a mechanism for managing tasks undertaken by objects.
8. An infrastructure according to preference 1 including a mechanism for signing an object.
9. An infrastructure according to preference 1 including a mechanism for managing safeguarding data passed between objects.
10. An infrastructure according to preference 1 including a mechanism for creating an explicit relationship between objects.
11. An infrastructure according to preference 1 including a mechanism for managing a role for an object.
12. An infrastructure according to preference 1 including a mechanism for defining rules.
13. An infrastructure according to preference 1 including a mechanism for assigning rules to tasks.
14. An infrastructure according to preference 1 including a mechanism for assigning rules to objects.
15. An infrastructure according to preference 1 including a mechanism for assigning rules to roles.
16. An infrastructure according to preference 1 including a mechanism for assigning rules to a relationship.
17. An infrastructure according to preference 1 including a mechanism for storing and retrieving of configuration data.
18. An infrastructure according to preference 1 including a mechanism for measuring activity between objects.
19. An infrastructure according to preference 1 including a mechanism for recording measured activity between objects.
20. An infrastructure according to preference 1 including a mechanism for assessing trustworthiness in a given interaction.
21. An infrastructure according to preference 1 including a mechanism for verification of a name.
22. An infrastructure according to preference 1 including a mechanism for extending the function of the infrastructure.
23. An infrastructure according to preference 2, in which all identity attributes of an object previously agreed between the interacting objects must be present for an interaction to take place.
24. An infrastructure according to preference 2, wherein the owner of an object may create a new electronic naming relating to the object.
25. An infrastructure according to preference 2, wherein the owner of an object may revoke an electronic naming relating to the object.
26. An infrastructure according to preference 2 wherein naming is created in the owners' environment.
27. An infrastructure according to preference 2 wherein a second party may name an object where a relationship of principal/subordinate exists between them and the second party acts as principal.
28. An infrastructure according to preference 2 wherein a second party acting may revoke a name unless in a master/slave relationship.
29. An infrastructure according to preference 2 wherein the electronic naming is created by and therefore can only be destroyed by the object owner.
30. An infrastructure according to preference 2 wherein the object owner may control the level of security based on perceived risk.
31. An infrastructure according to preference 2 wherein the naming of an object is legally valid where it is self-generated by an object or its owner.
32. An infrastructure according to preference 2 wherein the concept defines an approach and a set of processes and tools for the self-management of an electronic naming.
33. An infrastructure according to preference 2 wherein the electronic naming is comprised of a number of attributes.
34. An infrastructure wherein an object in the infrastructure must be allocated a role.
35. An infrastructure according to preference 2 wherein the naming method creates a strong connection between the object and its name.
36. An infrastructure according to preference 2 wherein naming is valid as no third party is involved in naming.
37. An infrastructure according to preference 2 wherein the owner of naming data may set a date for expiry.
38. An infrastructure wherein one object or the other will propose a method of naming.
39. An infrastructure according to preference 2 wherein the other party may accept the proposed method of identification.
40. An infrastructure according to preference 2 wherein the other party may reject the proposed method of identification.
41. An infrastructure according to preference 2 wherein the other party may ignore the proposed method of identification.
42. An infrastructure according to preference 2 wherein the other party may conditionally accept the proposed method of identification with proposed changes.
43. An infrastructure according to preference 2 wherein the party who has not yet proposed a method of identification is required to do so.
44. An infrastructure according to preference 2 wherein privileged objects may be declared in the infrastructure.
45. An infrastructure according to preference 2 wherein the infrastructure operator is the only organisation with the tools and authority required to declare an object as being privileged.
46. An infrastructure according to preference 2 wherein the infrastructure operator is responsible for ensuring that rules relating to privileges are correctly assigned.
47. An infrastructure according to preference 2 wherein an object requesting privileges is required to make a formal request in writing.
48. An infrastructure according to preference 2 wherein the infrastructure operator is required to make additional checks to verify an object prior to assigning additional privileges.
49. An infrastructure according to preference 2 wherein the infrastructure operator is required to establish that the object owner confirms the legitimacy of the request for privileges.
50. An infrastructure according to preference 2 wherein the infrastructure operator may suspend the privileges of the object.
51. An infrastructure according to preference 2 wherein the infrastructure operator may revoke the privileges of the object.
52. An infrastructure according to preference 3, in which all authentication attributes of an object previously decided must be present for an interaction to take place.
53. An infrastructure according to preference 3, in which one object or the other will propose a method of authentication.
54. An infrastructure according to preference 3, in which the other object may accept the proposed method of authentication.
55. An infrastructure according to preference 3, in which the other object may reject the proposed method of authentication.
56. An infrastructure according to preference 3, in which the other object may ignore the proposed method of authentication.
57. An infrastructure according to preference 3, in which the other object may conditionally accept the proposed method of authentication with proposed changes.
58. An infrastructure according to preference 3, in which the party who has not yet proposed a method of authentication is required to do so as defined in preferences 53 to 57.
59. An infrastructure according to preference 3, in which an organisation may not make use of the infrastructure without a base set of third party references.
60. An infrastructure according to preference 3, in which third party references required to verify an organisation will vary by country.
61. An infrastructure according to preference 3, in which third party references required to verify an organisation will vary by legal system.
62. An infrastructure according to preference 3, in which third party references required to verify an organisation will vary by business convention.
63. An infrastructure according to preference 4, in which a lookup facility that acts as a mechanism for locating an object based on a search mechanism allowing a searching party to use one or more data items to search the directory.
64. An infrastructure according to preference 4, in which the naming of the directory is established.
65. An infrastructure according to preference 4, in which the authenticity of the directory is established.
66. An infrastructure according to preference 4, in which the rules under which the objects make use of the directory prevent the directory operator from misusing the directory data.
67. An infrastructure according to preference 4 in which an object may publish to others the network location of various objects.
68. An infrastructure according to preference 4 wherein two or more objects may create a private group for the purposes of exchanging data.
69. An infrastructure according to preference 4 wherein the directory will only publish data contained in the directory to identified and authenticated requestors.
70. An infrastructure according to preference 4 wherein the directory will establish a relationship with the directory entrant to ensure authenticity.
71. An infrastructure according to preference 4 wherein the directory will agree a set of rules with the entrant for the permitted use of their directory data.
72. An infrastructure according to preference 4 wherein the directory will agree a set of rules relating to regulatory compliance with the entrant.
73. An infrastructure according to preference 4 wherein the directory will agree a set of rules with the entrant relating to any charge that may be levied for the service.
74. An infrastructure according to preference 4 wherein the directory will establish a relationship with the directory requestor to ensure authenticity.
75. An infrastructure according to preference 4 wherein the directory will agree a set of rules with the entrant for the permitted use of others data.
76. An infrastructure according to preference 4 wherein the directory will agree a set of rules relating to regulatory compliance with the requestor.
77. An infrastructure according to preference 4 wherein the directory will agree a set of rules with the requestor relating to any charge that may be levied for the service.
78. An infrastructure according to preference 5 wherein an object will select an object relationship.
79. An infrastructure according to preference 5 wherein an object will select a communications channel on which to communicate with the object.
80. An infrastructure according to preference 5 wherein an object will initiate the communication with the other object.
81. An infrastructure according to preference 5 wherein the software will read the configuration data to determine the rules that dictate how identification would be achieved.
82. An infrastructure according to preference 5 wherein both parties will identity to each other equally.
83. An infrastructure according to preference 5 wherein the software will read the configuration data to determine the rules that determine how authentication would be achieved.
84. An infrastructure according to preference 5 wherein the software will authenticate to each other equally.
85. An infrastructure according to preference 5 wherein the software will read the configuration data to determine the rules that dictate the method by which encryption would be achieved.
86. An infrastructure according to preference 5 wherein the software will then configure the encryption algorithm software.
87. An infrastructure according to preference 5 wherein the software will read the configuration data to determine the rules that dictate the method by which auditing would be achieved.
88. An infrastructure according to preference 5 wherein the software will then configure the audit process.
89. An infrastructure according to preference 5 wherein the software will read the configuration data to determine the rules that dictate how the communications session will be managed.
90. An infrastructure according to preference 5 wherein the software will then establish the communications session.
91. An infrastructure according to preference 5 wherein the network infrastructure has a point of control for each geographic territory.
92. An infrastructure according to preference 5 wherein other points of control must be added according to the degree of control required.
93. An infrastructure according to preference 5 wherein each point of control requires one or more security devices.
94. An infrastructure according to preference 5 wherein a ‘chain’ of safeguarding devices is required to ensure all devices in the chain are identified and authentic.
95. An infrastructure according to preference 5 wherein rogue appliance cannot be added to the ‘chain’ as the chain cannot have a ‘link’ inserted without being detected.
96. An infrastructure according to preference 5 wherein access to the infrastructure is controlled by a computer software application.
97. An infrastructure according to preference 5 wherein the software may be run on a range of devices.
98. An infrastructure according to preference 5 wherein the data is divided in a number of vertical ‘stripes’, so that alternate stripes are contained in separate files.
99. An infrastructure according to preference 5 wherein the software provides a series of choices that allows the user to configure how the striping works.
100. An infrastructure according to preference 5 wherein the software client is authenticated with the global infrastructure at run time.
101. An infrastructure according to preference 5 wherein should the software fail to authenticate it will not be capable of interaction across the infrastructure.
102. An infrastructure according to preference 5 wherein on first use the user of the software is required to populate the identity database with the appropriate data.
103. An infrastructure according to preference 5 wherein on completion of the data input the initial encryption and signatures keys are generated.
104. An infrastructure according to preference 5 wherein the software license agreement will be provided for electronic signature by the user.
105. An infrastructure according to preference 5 wherein the user must sign the agreement and return it to the network operator for co-signature.
106. An infrastructure according to preference 5 wherein if the license is not signed by both parties, no license to operate will be granted and the software will terminate.
107. An infrastructure according to preference 5 wherein the licensed infrastructure will be updated to reflect the newly signed license.
108. An infrastructure according to preference 5 wherein the user may terminate the license agreement causing the license to become void.
109. An infrastructure according to preference 5 wherein the network operator may terminate the license agreement causing the license to become void.
110. An infrastructure according to preference 5 wherein the software no longer operates once the license agreement is terminated.
111. An infrastructure according to preference 5 wherein the data owner sets encryption rule(s) proportionate to the perceived risk.
112. An infrastructure according to preference 5 wherein the data owner selects the encryption algorithm.
113. An infrastructure according to preference 5 wherein the user is provided with complete choice of naming convention for the elements of the data store when it is divided up prior to writing to a storage device.
114. An infrastructure according to preference 6 wherein the software will record object actions in the audit data store.
115. An infrastructure according to preference 6 wherein the audit data store is encrypted by the system.
116. An infrastructure according to preference 6 wherein the audit data can only be decrypted by the system.
117. An infrastructure according to preference 6 wherein the software manages the recording of auditable events in a location defined by the organisation in a rule when acting in a role.
118. An infrastructure according to preference 6 wherein transaction may be recorded on the audit trail as required by a legal or regulatory body.
119. An infrastructure according to preference 6 wherein an independent organisation may provide an auditing service.
120. An infrastructure according to preference 6 wherein an organisation may nominate a third party organisation to record some or all audit data based on their specified rules.
121. An infrastructure according to preference 6 wherein the software manages the recording of auditable events in a location defined by the user in a rule when acting in a private role.
122. An infrastructure according to preference 6 wherein the user may encrypt the audit data to prevent access by unauthorised parties.
123. An infrastructure according to preference 6 wherein the evidential proof of rules applied to a give interaction or process is provided by the audit trail.
124. An infrastructure according to preference 7 wherein an object may create a task to be performed by an object.
125. An infrastructure according to preference 7 wherein an object may create a task to be performed by another object.
126. An infrastructure according to preference 7 wherein an object may accept a task to be performed.
127. An infrastructure according to preference 7 wherein an object may reject a task to be performed.
128. An infrastructure according to preference 7 wherein an object may ignore a task to be performed.
129. An infrastructure according to preference 7 wherein the action queue tracks actions awaiting attention.
130. An infrastructure according to preference 7 wherein the action queue is subdivided into actions awaiting the user's attention and actions the user is waiting for others to perform.
131. An infrastructure according to preference 7 wherein an object may progress an action on the action queue by selecting the item.
132. An infrastructure according to preference 7 wherein by selecting an item on the action queue the software will automatically select the relevant role the user must act in to progress the action.
133. An infrastructure according to preference 7 wherein on activating the role automatically, a check will be made with the organisation to ensure the person is still permitted to act in the role.
134. An infrastructure according to preference 7 wherein an object owner may permit an object to delegate a task to another object.
135. An infrastructure according to preference 7 wherein an object owner may prevent an object from delegating a task to another object.
136. An infrastructure according to preference 7 wherein an object owner may impose a rule on an object when allowing an object to delegate a task.
137. An infrastructure according to preference 8 wherein the object owner may create a new electronic signature.
138. An infrastructure according to preference 8 wherein the object owner may cancel an electronic signature.
139. An infrastructure according to preference 8 wherein an object owner may sign an object with an appropriate signature.
140. An infrastructure according to preference 8 wherein an object may prescribe a signature to be used in a particular process.
141. An infrastructure according to preference 8 wherein an object may require more than one signature on an object based on a rule.
142. An infrastructure according to preference 8 wherein an organisation may require a third party to record the use of a signature electronically.
143. An infrastructure according to preference 8 wherein all signing acts are audited in multiple locations.
144. An infrastructure according to preference 8 wherein an object must have an electronic signature.
145. An infrastructure according to preference 8 wherein an object may have more than one electronic signature.
146. An infrastructure according to preference 8 wherein separate signatures may be generated for each role.
147. An infrastructure according to preference 8 wherein a signature provided by an object owner is controlled by the object owner.
148. An infrastructure according to preference 9 wherein the infrastructure provides a range of mechanisms for the safeguarding of the infrastructure.
149. An infrastructure according to preference 9 wherein the infrastructure provides for mechanisms to be configured as required by object owners.
150. An infrastructure according to preference 9 wherein a configuration of a safeguarding mechanism is achieved through the definition of a rule.
151. An infrastructure according to preference 9 wherein a safeguarding mechanism rule is defined by the owner of the data object.
152. An infrastructure according to preference 9 wherein a safeguarding mechanism attributes previously agreed between objects must be present for an interaction to take place.
153. An infrastructure according to preference 9 wherein one or more safeguarding devices may be used to manage interactions between entities.
154. An infrastructure according to preference 9 wherein a safeguarding mechanism may include a physical device.
155. An infrastructure according to preference 9 wherein the safeguarding device contains a data store protected by safeguarding mechanisms.
156. An infrastructure according to preference 9 wherein the safeguarding device data store contains safeguarding mechanism configuration data.
157. An infrastructure according to preference 9 wherein the safeguarding device data store contains a rule store.
158. An infrastructure according to preference 9 wherein the safeguarding device data store contains naming data.
159. An infrastructure according to preference 9 wherein the safeguarding device data store contains calendar data.
160. An infrastructure according to preference 9 wherein the safeguarding device data store contains audit data.
161. An infrastructure according to preference 9 wherein the safeguarding device data store contains other configuration data.
162. An infrastructure according to preference 9 wherein the safeguarding device contains an operating system.
163. An infrastructure according to preference 9 wherein the safeguarding device contains a file system.
164. An infrastructure according to preference 9 wherein the safeguarding device contains a network connection.
165. An infrastructure according to preference 9 wherein the security contains a communications protocol stack.
166. An infrastructure according to preference 9 wherein the safeguarding device may contain hardware device for managing one or more safeguarding mechanisms.
167. An infrastructure according to preference 9 wherein the network operator must authenticate the safeguarding device prior to it being accepted on the network.
168. An infrastructure according to preference 9 wherein the safeguarding device is tamper resistant.
169. An infrastructure according to preference 9 wherein the safeguarding device is tamper evident.
170. An infrastructure according to preference 9 wherein the network operator is able to detect tampering.
171. An infrastructure according to preference 9 wherein the network operator is able to de-activate a safeguarding device.
172. An infrastructure according to preference 9 wherein a safeguarding device is protected against unauthorised and undetected reconfiguration.
173. An infrastructure according to preference 9 wherein safeguarding devices form a ‘mesh’ on which the reliability, security and trustworthiness of the global infrastructure is built and based.
174. An infrastructure according to preference 9 wherein the identity of each appliance is globally unique and known only to the network operator.
175. An infrastructure according to preference 9 wherein the inclusion of the appliance in the network is dependent on the appliance being trusted.
176. An infrastructure according to preference 9 wherein trust is established by a safeguarding device being identified and authenticated by many objects including other safeguarding objects.
177. An infrastructure according to preference 9 wherein a safeguarding device which cannot be identified and authenticated by many objects can be detected and classified as rogue.
178. An infrastructure according to preference 9 wherein a safeguarding device which has been classified as rogue can be prevented from participating in the infrastructure.
179. An infrastructure according to preference 9 wherein the user is required to select diverse locations for each collection of ‘striped’ data.
180. An infrastructure according to preference 9 wherein a hostile party will be unable to ascertain where the data portions are stored.
181. An infrastructure according to preference 9 wherein identity data store is safeguarded based on an approach chosen by the data owner.
182. An infrastructure according to preference 9 wherein the object owner selects a method for safeguarding the data.
183. An infrastructure according to preference 9 wherein the object owner will generate the required token to enable the data to be safeguarded.
184. An infrastructure according to preference 9 wherein the data owner has the optional combination of two or more keys to further strengthen the encryption of the data store.
185. An infrastructure according to preference 9 wherein two or more safeguarding methods may be employed to increase the difficulty of an attack by a hostile party.
186. An infrastructure according to preference 9 wherein the safeguarding device is uniquely configured for a given purpose and may not be used for another purpose.
187. An infrastructure according to preference 9 wherein the unique configuration means that a safeguarding device will not be usable by another organisation.
188. An infrastructure according to preference 9 wherein the chain of safeguarding devices make it extremely difficult for a rogue safeguarding device to be added to the infrastructure.
189. An infrastructure according to preference 10 wherein the owner of an object may define a relationship.
190. An infrastructure according to preference 10 wherein a second party may request a new relationship.
191. An infrastructure according to preference 10 wherein the second party may cancel a relationship.
192. An infrastructure according to preference 10 wherein the object owner may revoke or cancel a relationship.
193. An infrastructure according to preference 10 wherein the party wishing to form a relationship will send a request to the other party or object.
194. An infrastructure according to preference 10 wherein the other party or object will receive the relationship request.
195. An infrastructure according to preference 10 wherein the software will display the request in a list of tasks awaiting action.
196. An infrastructure according to preference 10 wherein the user may agree to the relationship request.
197. An infrastructure according to preference 10 wherein the user may reject the relationship request.
198. An infrastructure according to preference 10 wherein the user may ignore the relationship request.
199. An infrastructure according to preference 10 wherein one party or the other will propose one or more rules relating to regulatory or legal compliance.
200. An infrastructure according to preference 10 wherein the other party may accept the proposed rules relating to regulatory or legal compliance.
201. An infrastructure according to preference 10 wherein the other party may reject the proposed rules relating to regulatory or legal compliance.
202. An infrastructure according to preference 10 wherein the other party may ignore the proposed rules relating to regulatory or legal compliance.
203. An infrastructure according to preference 10 wherein the other party may conditionally accept the proposed rules relating to regulatory or legal compliance with proposed changes.
204. An infrastructure according to preference 10 wherein the party who has not yet proposed a method one or more rules relating to regulatory or legal compliance may do so.
205. An infrastructure according to preference 10 wherein one party or the other will propose one or more rules relating to terms and conditions.
206. An infrastructure according to preference 10 wherein the other party may accept the proposed rules relating to terms and conditions.
207. An infrastructure according to preference 10 wherein the other party may reject the proposed rules relating to terms and conditions.
208. An infrastructure according to preference 10 wherein the other party may ignore the proposed rules relating to terms and conditions.
209. An infrastructure according to preference 10 wherein the other party may conditionally accept the proposed rules relating to terms and conditions with proposed changes.
210. An infrastructure according to preference 10 wherein the party who has not yet proposed a method one or more rules relating to terms and conditions may do so.
211. An infrastructure according to preference 10 wherein the configuration data is stored in encrypted form, which is further encrypted in the data store of the respective parties.
212. An infrastructure according to preference 10 wherein one party or the other will propose the basis for the relationship.
213. An infrastructure according to preference 10 wherein the other party may accept the proposed basis for the relationship.
214. An infrastructure according to preference 10 wherein the other party may reject the proposed basis for the relationship.
215. An infrastructure according to preference 10 wherein the other party may ignore the proposed basis for the relationship.
216. An infrastructure according to preference 10 wherein the other party may conditionally accept the proposed basis of the relationship with proposed changes.
217. An infrastructure according to preference 10 wherein the concept defines three methods by which a third party reference may be obtained.
218. An infrastructure according to preference 11 wherein a role must be defined before it can be assigned to an object.
219. An infrastructure according to preference 11 wherein a role must be assigned its position in the relevant hierarchy within the organisation.
220. An infrastructure according to preference 11 wherein a role may be either peer-to-peer or master/slave.
221. An infrastructure according to preference 11 wherein a relationship between a person and an object is always master/slave where the person acts as the master.
222. An infrastructure according to preference 11 wherein a relationship between two objects may be peer-to-peer.
223. An infrastructure according to preference 11 wherein a relationship between two objects may be master/slave.
224. An infrastructure according to preference 11 wherein a user may define one or more roles for themselves.
225. An infrastructure according to preference 11 wherein a person must always act in a role.
226. An infrastructure according to preference 11 wherein if no explicit role is chosen the default role of private person is allocated.
227. An infrastructure according to preference 11 wherein this data specifying the role shall include the start date.
228. An infrastructure according to preference 11 wherein the data specifying the role shall include a role title.
229. An infrastructure according to preference 11 wherein the data specifying the role shall include the organisation offering the role.
230. An infrastructure according to preference 11 wherein the data specifying the role may include an end date.
231. An infrastructure according to preference 11 wherein the data specifying the role may include the terms under which the role is offered.
232. An infrastructure according to preference 11 wherein the data specifying the role may include an electronic signature generated by the organisation for use when signing in the role.
233. An infrastructure according to preference 11 wherein an organisation may offer a role to a person via a communication channel and the defined relationship.
234. An infrastructure according to preference 11 wherein the person offered a role may choose to accept or declined a role offered to them.
235. An infrastructure according to preference 11 wherein should the offered role be accepted the electronic identity is associated with the electronic role.
236. An infrastructure according to preference 11 wherein when a person acts in a role, the identity and role are both used to ensure liability is appropriately assigned.
237. An infrastructure according to preference 11 wherein when a person acts in a role, the identity and role are recorded in the audit trail.
238. An infrastructure according to preference 11 wherein should the offered role be accepted the data store on the device in the organisation is updated appropriately.
239. An infrastructure according to preference 11 wherein the user may commence acting in the role once the start date is reached.
240. An infrastructure according to preference 11 wherein the privileges assigned to the role are activated from the defined date.
241. An infrastructure according to preference 11 wherein the responsibilities assigned to the role are activated from the defined date.
242. An infrastructure according to preference 11 wherein a person previously acting in a role is removed from the role once the end date is reached.
243. An infrastructure according to preference 11 wherein a person or organization may assign a role to an object.
244. An infrastructure according to preference 11 wherein the object role defines the purpose to which the object may be put.
245. An infrastructure according to preference 11 wherein the object role defines the objects which may access the object.
246. An infrastructure according to preference 11 wherein the object role defines the method of identification of another object.
247. An infrastructure according to preference 11 wherein the object role defines the method of authentication of another object.
248. An infrastructure according to preference 11 wherein the object role defines the method of encryption used for communications between the objects.
249. An infrastructure according to preference 11 wherein the object role defines the method of establishing a communications session between the objects.
250. An infrastructure according to preference 12, in which all rule attributes of an object previously agreed between objects must be present for an interaction to take place.
251. An infrastructure according to preference 12 wherein the object owner may publish credentials to the directory.
252. An infrastructure according to preference 12 wherein the user may remove credentials from the directory.
253. An infrastructure according to preference 12 wherein a third party may not cancel a relationship.
254. An infrastructure according to preference 12 wherein trust may be assessed by parties in an interaction by their subjective judgement based on data provided.
255. An infrastructure according to preference 12 wherein an electronic identity is created by the owner and does not rely on a second party creator to be trusted.
256. An infrastructure according to preference 12 wherein an electronic identity cannot be given to the wrong party in error as the creator is the subject of the identity.
257. An infrastructure according to preference 12 wherein the authenticity of an electronic identity is not bound to a technical object which itself cannot demonstrate adequate proof of identity such as the Internet DNS (Domain Name Server).
258. An infrastructure according to preference 12 wherein security is managed end-to-end in a known configuration eradicating weaknesses caused by unknown configuration weaknesses.
259. An infrastructure according to preference 12 wherein a rule may be defined to ensure that configuration of the digital naming and its use conforms to local laws.
260. An infrastructure according to preference 12 wherein where a person acts in a role, other than one that restricts them from doing so, they are able to define personal rules.
261. An infrastructure according to preference 12 wherein personal rules are stored in machine-readable form.
262. An infrastructure according to preference 12 wherein personal rules may be output in printed form by applying a style sheet.
263. An infrastructure according to preference 12 wherein the format of a personal rule is restricted by a structure defined in a rule template.
264. An infrastructure according to preference 12 wherein personal rules are stored in encrypted form and further encrypted when stored in the data store.
265. An infrastructure according to preference 12 wherein the user may define a new personal rule.
266. An infrastructure according to preference 12 wherein the user may modify a personal rule.
267. An infrastructure according to preference 12 wherein the user may attach a personal rule to a process.
268. An infrastructure according to preference 12 wherein the user may detach a personal rule from a process.
269. An infrastructure according to preference 12 wherein a personal rule has a unique system identity.
270. An infrastructure according to preference 12 wherein a modified personal rule has a different unique system identity from its predecessor.
271. An infrastructure according to preference 12, wherein the act of modifying a personal rule is tracked and traced in an audit trail.
272. An infrastructure according to preference 12 wherein personal rules are encrypted based on the relevant encryption rule.
273. An infrastructure according to preference 12 wherein personal rules are stored in the users data store.
274. An infrastructure according to preference 12 wherein a person acting in an approved role may define an organisation rule.
275. An infrastructure according to preference 12 wherein organisation rules are stored in machine-readable form.
276. An infrastructure according to preference 12 wherein organisation rules may be output in printed form by applying a style sheet.
277. An infrastructure according to preference 12 wherein the format of an Organisation rule is restricted by a structure defined in a rule template.
278. An infrastructure according to preference 12 wherein organisation rules are stored in encrypted form and further encrypted when stored in the data store.
279. An infrastructure according to preference 12 wherein a person acting in an approved role may modify an organisation rule.
280. An infrastructure according to preference 12 wherein a person acting in an approved role may attach an organisation rule to a process.
281. An infrastructure according to preference 12 wherein a person acting in an approved role may detach an organisation rule from a process.
282. An infrastructure according to preference 12 wherein an organisation rule has a unique system identity.
283. An infrastructure according to preference 12 wherein a modified organisation rule has a different unique system identity from its predecessor.
284. An infrastructure according to preference 12 wherein all organisation rule changes are recorded in the audit trail.
285. An infrastructure according to preference 12 wherein organisation rules are stored in the organisation safeguarding device or appliances.
286. An infrastructure according to preference 12 wherein the calendar function in the safeguarding device or appliances tracks the usage of active organisation rules.
287. An infrastructure according to preference 12 wherein the calendar function in the safeguarding device or appliances tracks the historic use of organisation rules.
288. An infrastructure according to preference 13 wherein a rule is assigned to a task.
289. An infrastructure according to preference 13 wherein the task owner controls who may assign a rule to a task.
290. An infrastructure according to preference 13 wherein the task owner control who may remove a rule from a task.
291. An infrastructure according to preference 13 wherein the act of changing the assignment of a rule to a task must be recorded.
292. An infrastructure according to preference 14 wherein a rule may be assigned to an object.
293. An infrastructure according to preference 14 wherein an object owner controls who may assign a rule to an object.
294. An infrastructure according to preference 14 wherein the act of changing the assignment of a rule to an object must be recorded.
295. An infrastructure according to preference 15 wherein a rule may be assigned to a role.
296. An infrastructure according to preference 15 wherein an object owner controls who may assign a rule to a role.
297. An infrastructure according to preference 15 wherein the act of changing the assignment of a rule to an object must be recorded.
298. An infrastructure according to preference 16 wherein a rule may be assigned to a relationship.
299. An infrastructure according to preference 16 wherein a relationship owner controls who may assign a rule to a relationship.
300. An infrastructure according to preference 16 wherein the act of changing the assignment of a role to a relationship must be recorded.
301. An infrastructure according to preference 16 wherein technical events on all appliances are recorded in the audit trail.
302. An infrastructure according to preference 18 wherein activity on the infrastructure is measurable.
303. An infrastructure according to preference 18 wherein activity on the infrastructure may be exempt from measurement where an object connected to the activity has special privileges.
304. An infrastructure according to preference 19 wherein the measured activity is recorded within the infrastructure for later analysis.
305. An infrastructure according to preference 20 wherein an object is provided with sufficient information by the infrastructure to enable it to make an assessment of trust in another object.
306. An infrastructure according to preference 20 wherein an object is provided with sufficient information by the infrastructure to enable it to make an assessment of trust in a naming.
307. An infrastructure according to preference 20 wherein an object is provided with sufficient information by the infrastructure to enable it to make an assessment of trust in a relationship.
308. An infrastructure according to preference 20 wherein an object is provided with sufficient information by the infrastructure to enable it to make an assessment of trust in an object acting in a role.
309. An infrastructure according to preference 20 wherein an object is provided with sufficient information by the infrastructure to enable it to make an assessment of trust in a process.
310. An infrastructure according to preference 20 wherein an object is provided with sufficient information by the infrastructure to enable it to make an assessment of trust in a recording.
311. An infrastructure according to preference 20 wherein an object is provided with sufficient information by the infrastructure to enable it to make an assessment of trust in a measurement.
312. An infrastructure according to preference 21 wherein the subject may apply to a reference provider for a reference.
313. An infrastructure according to preference 21 wherein the subject may instruct another party to obtain a reference from a nominated reference provider.
314. An infrastructure according to preference 21 wherein the subject may instruct a reference provider to provide a reference to a nominated third party.
315. An infrastructure according to preference 21 wherein where a reference provider accepts the subjects' request to provide a reference to a nominated third party, they will first create a relationship to ensure the authenticity of the other party.
316. An infrastructure according to preference 21 wherein the reference provider may accept the request to provide a reference in electronic or other form.
317. An infrastructure according to preference 21 wherein the reference provider may reject the request to provide a reference in electronic or other form.
318. An infrastructure according to preference 21 wherein the reference provider may ignore the request to provide a reference in electronic or other form.
319. An infrastructure according to preference 21 wherein the reference provider may conditionally accept the request to provide a reference in electronic or other form but with proposed changes.
320. An infrastructure according to preference 21 wherein the reference provider may stipulate a fee or fees for providing a reference.
321. An infrastructure according to preference 21 wherein the reference provider may stipulate one or more restrictions on the usage of the reference.
322. An infrastructure according to preference 21 wherein the subject of the reference, the user, may provide the reference provider with legal authority to pass reference data to an approved third party.
323. An infrastructure according to preference 21 wherein the reference provider will store the reference data in their safeguarding device.
324. An infrastructure according to preference 21 wherein the reference providers' safeguarding device will record the creation of the reference in the audit trail.
325. An infrastructure according to preference 21 wherein the reference providers' safeguarding device will record the provision of the reference to the subject.
326. An infrastructure according to preference 21 wherein the reference providers' safeguarding device will record the various terms agreed with the subject.
327. An infrastructure according to preference 21 wherein the user may create a number of hashes from secret information such as a reference.
328. An infrastructure according to preference 21 wherein the user may use hashed secrets to reinforce a claimed identity.
329. An infrastructure according to preference 21 which eradicates the difficulty of integration with computer systems and applications as the concept abstracts the identity/authentication phase from the interaction.
330. An infrastructure according to preference 22 wherein an object owner may extend the functionality of the infrastructure based on an application programming interface provided by the network operator.
331. An infrastructure according to preference 22 wherein the application programming interface ensures that the application correctly handles naming.
332. An infrastructure according to preference 22 wherein the application programming interface ensures that the application correctly handles authentication.
333. An infrastructure according to preference 22 wherein the application programming interface ensures that the application correctly handles rules.
334. An infrastructure according to preference 22 wherein the application programming interface ensures that the application correctly handles roles.
335. An infrastructure according to preference 22 wherein the application programming interface ensures that the application correctly handles relationships.
336. An infrastructure according to preference 22 wherein the application programming interface ensures that the application correctly handles measuring.
337. An infrastructure according to preference 22 wherein the application programming interface ensures that the application correctly handles recording.
338. An infrastructure according to preference 22 wherein a software application developed using the application programming interface may be trusted by users based on their subjective judgment.
339. An infrastructure according to preference 22 wherein an object owner wishing to extend the functionality of the infrastructure using the application programming interface must register the application for it to operate.
340. An infrastructure according to preference 22 wherein the infrastructure maintains a list of registered applications approved for operation on the infrastructure.
341. An infrastructure according to preference 22 wherein the infrastructure operator will update the licensing data store with the relevant application information.
342. An infrastructure according to preference 22 wherein the infrastructure operator will distribute the license data to appropriate safeguarding devices.
343. An infrastructure according to preference 22 wherein a software application developed using the application programming interface will be certified by the network operator prior to availability.
344. An infrastructure according to preference 22 wherein a software application developed using the application programming interface will include an interface to the measuring functionality of the infrastructure.
345. An infrastructure according to preference 22 wherein a software application developed using the application programming interface may generate measuring data.

1. An infrastructure for the enablement of trustworthy and confidential communications between two or more objects within said infrastructure.

2. An infrastructure according to claim 1 comprising a network of protected endpoints for transmitting or exchanging digital data, the network including first and second protected endpoints, each protected endpoint being under the control of a respective first and second object, which may transmit or exchange messages therebetween including a mechanism for mutually asserting the identity of a person or object as part of a digital transmission or exchange over the network of protected endpoints, wherein each object has a plurality of data items relating to the identity of the object, wherein each said item is independently verifiable by a respective third party which third party is different for each item of said plurality, and wherein a digital transmission or exchange between said objects includes as a preliminary step exchange of an amount of data contained in each objects database, so as to verify identity of each object by the other object to a desired degree.

3. An infrastructure according to claim 2, wherein said items of information are held in a database, the database including identity data and one or more of authentication data, role information, relationships, references and rules.

4. A infrastructure according to claim 3, wherein the database is encrypted at least once and some parts more than once.

5. A infrastructure according to claim 3, wherein the database is split into two equal or unequal parts and stored in two places.

6. A infrastructure according to claim 2 further comprising a mechanism for creating, managing assigning and enforcing rules as part of the digital transmission exchange over the network and wherein a digital exchange between said objects includes as a preliminary step configurable handshaking to match security level to exposure to risk and security policy of the interacting parties.

7. An infrastructure according to claim 2 further comprising a mechanism for managing security issues arising from transmission or exchange of digital data over the network, wherein the mechanism includes stored data in digital form for each object comprising a plurality of data items relating to the identity of the object, the role of each object is defined in digital form to the satisfaction of both objects, a set of rules are defined in digital form to regulate transmission or exchange of data between the objects, the set of rules including technical requirements and also rules relating to the form of digital data.

8. A process for managing security issues across a network of protected endpoints, the network including first and second protected endpoints, each protected endpoint being under the control of a respective first and second object, which may transmit messages therebetween, the process comprising:
each object defining in digital form items of data establishing the object's identity;
each object defining in digital form the nature of the relationship to be established with another object, the role of the object within that relationship, and rules to be applied for the carrying out of transactions,
the objects exchanging communications across the network to establish identity to the other objects satisfaction, and to agree said role and rules, whereby to establish an agreement governing transactions between the objects
and the objects subsequently carrying out transactions within the terms of the agreement.

9. A mechanism for trusted communication for a computer network, the network including first and second protected endpoints, the first protected endpoint being under the control of a first object, the protected endpoint being under the control of a second object, said first and second protected endpoints being coupled to a configuration file means, said configuration file means specifying the conditions under which communication transactions may take place between said first and second protected endpoints, and the configuration file means including identity data of the first and second objects, to be exchanged between the objects, the identity data including one or more reference items of identity reference data, and the configuration file means defining the type and amount of safeguarding of data which is employed, and the network optionally including one or more audit mechanisms for providing independent verification of said reference items.

10. A process according to claim 8 for carrying out secure communication in transactions across the said network, the process comprising forming digitally a relationship between the first and second objects thereby to enable said transmission of messages therebetween, by each object exchanging in digital form identity data with the other to a degree that satisfies the other object, the identity data including at least one item of reference identity data, and the network optionally including one or more audit mechanisms for providing independent verification of the reference items, agreeing data safeguarding procedures to be carried out, and providing a configuration file means which regulates transactions between the first and second objects and which specifies the conditions under which communication transactions may take place between said first and second protected endpoints, the degree of identity data to be exchanged between the objects, the identity reference data required, and the type and amount of data safeguarding employed.

11. A mechanism as claimed in claim 9, wherein each said database is encrypted.

12. A mechanism as claimed in claim 9, wherein each database is split, and stored in two different locations.

13. A mechanism as claimed in claim 9, wherein the first processor device has an associated first database storing a first version of said configuration file means, and the second processor device having an associated second database storing a second version of said configuration file means.

14. A mechanism as claimed in claim 9, wherein said configuration file means includes technical rules as to encryption, and keys for symmetric/asymmetric encryption.

15. A mechanism as claimed in claim 9, including agreeing a set of rules for conducting transactions, including a set of rules setting out legally obligatory measures, and a set of rules setting out technical measures, and including said type and amount of data safeguarding, and storing said rules in said configuration file means.

16. A mechanism as claimed in claim 9, including specifying a role which the respective object is obliged to carry out within an organisation, and said rules specify conditions under which transactions may take place within said role, and said role is stored in said configuration file means.

17. A mechanism as claimed in claim 9, wherein a relationship with the other object is defined in said configuration file means.

18. A mechanism as claimed in claim 9, wherein said configuration file means contains an audit trail which records past transactions across the network.

19. An infrastructure according to claim 1 including a mechanism for the naming of an object.

20. An infrastructure according to claim 1 including a mechanism for the authentication of an object.

21-39. (canceled)
